(19) United States
(12) Patent Application Publication
(10) Pub. No.: US 2009/0033839 A1
(43) Pub. Date: Feb. 5, 2009

(54) RETARDATION FILM, POLARIZING PLATE, AND LIQUID CRYSTAL DISPLAY DEVICE COMPRISING IT

(75) Inventor: Kenichi FUKUDA, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/181,793

(22) Filed: Jul. 29, 2008

(30) Foreign Application Priority Data
Jul. 30, 2007 (JP) 2007-197082
Aug. 20, 2007 (JP) 2007-213601

(51) Int. Cl. G02F 1/1335; C09K 19/00

(52) U.S. Cl. 349/102; 349/117; 428/1.31

(57) ABSTRACT

Provided is a retardation film comprising a polymer film, and, disposed thereon, an optically-anisotropic layer, of which thickness is equal to or less than 5 μm, of which in-plane retardation at a wavelength of 550 nm, Re(550), is from 0 to 10 nm, and of which thickness-direction retardation at the same wavelength, Rth(550), is from 250 to 450 nm; and satisfying the following formula: 1.00≦Rth(450)/Rth(550)≦1.07 or 1.04≦Rth(450)/Rth(550)≦1.09.

### CROSS-REFERENCE TO RELATED APPLICATIONS

This application claims benefit of priority under 35 U.S.C. 119 to Japanese Patent Application Nos. 2007-197082 filed on Jul. 30, 2007 and 2007-213601 filed on Aug. 20, 2007; and the entire contents of the applications are incorporated herein by reference.

### BACKGROUND OF THE INVENTION

1. Technical Field of the Invention

The present invention relates to a novel retardation film, polarizing plate and liquid-crystal display device comprising it.

2. Related Art

Heretofore, wide viewing-angle liquid-crystal systems of IPS (in-plane switching) mode, OCB (optically compensatory Bend) mode, and VA (vertically aligned) mode have been proposed, and with the recent increase in the demand for liquid-crystal TVs, their share is expanding. Every system is improved in the display quality; however, the problem of color shift occurring in oblique directions is not as yet solved.

For solving the problem of color shift, an optical compensatory system is disclosed, mainly comprising a negative C-plate compensatory film and a positive A-plate compensatory film, for VA-mode liquid-crystal display devices. For example, U.S. Pat. No. 4,889,412 discloses an ordinary VA-mode liquid-crystal display device that comprises a negative C-plate compensatory film.

However, in such an ordinary VA-mode liquid-crystal display device that comprises a negative C-plate compensatory film, the compensation in the black state is not complete, therefore having a problem of viewing angle-dependent light leakage.

As opposed to it, U.S. Pat. No. 6,141,075 discloses an ordinary VA-mode liquid-crystal display device that comprises both a negative C-plate compensatory film and a positive A-plate compensatory film. This could solve the problem of light leakage in the black state.

However, even in such an ordinary VA-mode liquid-crystal display device that comprises both a negative C-plate compensatory film and a positive A-plate compensatory film, the problem of color shift in oblique directions in the black state could not still be solved sufficiently.

On the other hand, disclosed is a VA-mode liquid-crystal display device that comprises, for example, two retardation films having different optical properties, in which the display by the device is sharp and colorless when watched in oblique directions in the black state (for example, see WO2003/032060).

However, in actually incorporating the two different types of retardation films into a liquid-crystal display device, they are incorporated thereinto, each as integrated with a polarizing plate; however, an additional step of sticking the two retardation films having predetermined optical properties to polarizing plates, previously prepared, is required. Accordingly, the method is problematic in that the production process is complicated, the producibility is low and the production cost is high; and it is desired to solve the problems.

As opposed to this, for example, JPA No. 2000-304931 proposes an optical compensation sheet for VA-mode liquid-crystal display devices, which comprises a transparent support, and an optically-anisotropic layer formed of discotic liquid-crystal molecules. When a cellulose acylate film is used for the transparent support, then the cellulose acylate film may serve also as a protective film for the polarizer, and the above-mentioned problem of producibility can be thereby solved. However, in order to attain the optical properties necessary for optical compensation in VA-mode liquid-crystal display devices, thickness-direction retardation (Rth) should be 300 nm or so; and for realizing it, the optically-anisotropic layer should be thick. When such a thick optically-anisotropic layer is formed by coating, there may occur a problem of coating unevenness.

The retardation of a retardation plate formed of a polymer film or the like is not always the same value at every wavelength, but varies in some degree depending on the wavelength of incident light (this property is hereinafter referred to as “wavelength dispersion characteristics of retardation”). Of polymer films, some have wavelength dispersion characteristics of retardation of such that the retardation increases toward the shorter wavelength of incident light (hereinafter this is referred to as “regular wavelength dispersion characteristics of retardation”) and others have wavelength dispersion characteristics of retardation of such that the retardation decreases toward the shorter wavelength of incident light (hereinafter this is referred to as “reversed wavelength dispersion characteristics of retardation”). On the other hand, the birefringence of liquid-crystal cells may also have wavelength dispersion characteristics of retardation; and for achieving more ideal optical compensation for liquid-crystal cells, the wavelength dispersion characteristics of retardation of retardation plates may have to be controlled similarly thereto in some cases.

For example, proposed is use of a negative C-plate for optical compensation for VA-mode liquid-crystal cells in the black state; however, when the wavelength dispersion characteristics of thickness-direction retardation (Rth) of the negative C-plate is not similar to the wavelength dispersion characteristics of retardation of the VA-mode liquid-crystal cell, then there may occur a problem of viewing angle-dependent color shift.

However, of the polymer film that is heretofore used as the retardation plate of a VA-mode liquid-crystal cell, the wavelength dispersion characteristics of the retardation is difficult to be controlled, and it is difficult to produce a retardation plate having ideal wavelength dispersion characteristics of retardation similar to that of the birefringence of the liquid-crystal cell. In particular, it is difficult to prepare a polymer film that has an absolute value of Rth in some degree and has, as the optical characteristics thereof, regular wavelength dispersion characteristics of the retardation Rth; and even though an additive or the like is added to the polymer film so as to control it, there still remains a problem in that both the wavelength dispersion characteristics of the retardation Rth and the level of Rth could not be controlled at the same time.

As so mentioned in the above, for optical compensation in VA-mode liquid-crystal display devices, thickness-direction retardation (Rth) should be 300 nm or so; and for realizing it, the optically-anisotropic layer is required to have a thickness-direction retardation (Rth) of at least 200 nm or so. In such a system, the wavelength dispersion characteristics of the retardation of the optically-anisotropic layer are dominant, and when the anisotropic layer is formed of a discotic liquid-crystal compound, the wavelength dispersion characteristics of retardation thereof are significant and therefore it is difficult to attain a desired level of wavelength dispersion characteristics of retardation as a whole. In that situation, it is desired to provide an optical compensatory film having excellent optical compensatory capability for various modes, especially VA-modes of liquid-crystal cells.

JPA No. 2006-076992 discloses a discotic liquid-crystal compound having low wavelength dispersion characteristics of retardation and having large refractivity anisotropy. However, its wavelength dispersion characteristics of retardation, Rth(450)/Rth(550) is at least 1.1; and when it is, the compound could not directly form a retardation film having wavelength dispersion characteristics of retardation necessary for optical compensation in VA-mode liquid-crystal display devices.

In one embodiment of the optical compensation for VA-mode liquid-crystal display devices, it is desired to provide a retardation film with no unevenness capable of being used also as a protective film for polarizing plate and having the wavelength dispersion characteristics of retardation similar to those of the VA-mode liquid-crystal cell therein.

### SUMMARY OF THE INVENTION

An object of the invention is to provide novel retardation films and polarizing plates useful for optical compensation in liquid-crystal display devices, especially VA-mode liquid-crystal display devices and, in particular, capable of contributing toward reduction in the color shift occurring in oblique directions.

Another object of the invention is to provide liquid-crystal display devices, especially VA-mode liquid-crystal display devices in which the contrast are improved and the color shift depending on the viewing direction in the black state is reduced.

The means for achieving the above mentioned objects are as follows.
[1] A retardation film comprising:

a polymer film, and, disposed thereon,

an optically-anisotropic layer, of which thickness is equal to or less than 5 μm, of which in-plane retardation at a wavelength of 550 nm, Re(550), is from 0 to 10 nm, and of which thickness-direction retardation at the same wavelength, Rth(550), is from 250 to 450 nm;

and satisfying the following formula (1-1):

1.00≦Rth(450)/Rth(550)≦1.07 (1-1).
[2] A retardation film comprising:

a polymer film, and, disposed thereon,

an optically-anisotropic layer, of which thickness is equal to or less than 5 μm, of which in-plane retardation at a wavelength of 550 nm, Re(550) is from 0 to 10 nm, and of which thickness-direction retardation at the same wavelength, Rth(550) is from 200 to 400 nm;

and satisfying the following formula (1-2):

1.04≦Rth(450)/Rth(550)≦1.09 (1-2).
[3] The retardation film as set forth in [1] or [2], wherein in-plane retardation at a wavelength of 550 nm of the optically-anisotropic layer, Re(550), is from 0 to 10 nm, thickness-direction retardation at the same wavelength thereof, Rth(550), is from 200 to 400 nm, and the layer satisfies the following formula (2):

1.05≦Rth(450)/Rth(550)≦1.15 (2).
[4] The retardation film as set forth in any one of [1] to [3], wherein the value, Rth(550)/d, calculated by dividing thickness-direction retardation at a wavelength of 550 nm, Rth(550), of the optically-anisotropic layer by the thickness, d, of the optically-anisotropic layer is equal to or more than 0.080.
[5] The retardation film as set forth in any one of [1] to [4], wherein the optically-anisotropic layer is formed of a polymerizable composition.
[6] The retardation film of [5], wherein the polymerizable composition comprises at least one discotic liquid-crystal compound, having polymerizable group(s), and in the optically-anisotropic layer, the discotic structure unit of the discotic liquid-crystal compound is aligned horizontally to the layer face.
[7] The retardation film of [6], wherein said at least one discotic liquid-crystal compound is a compound represented by the following formula (DI):

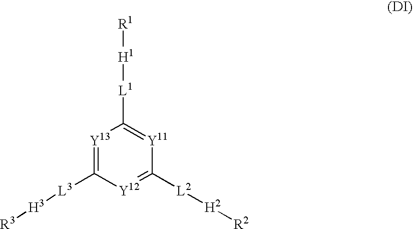

where Y¹¹, Y¹² and Y¹³ each independently represent a methine group or a nitrogen atom; L¹, L² and L³ each independently represent a single bond or a bivalent linking group; H¹, H² and H³ each independently represent following formula (DI-A) or (DI-B); and R¹, R² and R³ each independently represent following formula (DI-R)

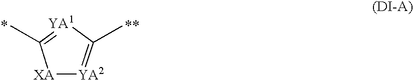

where, in formula (DI-A), YA¹ and YA² each independently represent a methine group or a nitrogen atom; XA represents an oxygen atom, a sulfur atom, a methylene group or an imino group; * indicates the position at which the formula bonds to any of L¹ to L³; and ** indicates the position at which the formula bonds to any of R¹ to R³:

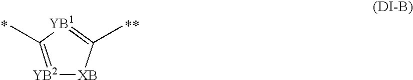

where, in formula (DI-B), YB¹ and YB² each independently represent a methine group or a nitrogen atom; XB represents an oxygen atom, a sulfur atom, a methylene group or an imino group; * indicates the position at which the formula bonds to any of L¹ to L³; and ** indicates the position at which the formula bonds to any of R¹ to R³:

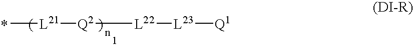

where, in formula (DI-R), * indicates the position at which the formula bonds to H¹, H² or H³ in formula (DI); L²¹ represents a single bond or a bivalent linking group; Q² represents a bivalent linking group having at least one cyclic structure; n1 indicates an integer of from 0 to 4; L²² represents —O—, —O—CO—, —CO—O—, —O—CO—O—, —S—, —NH—, —SO₂—, —CH₂—, —CH═CH— or —C—C—, provided that, when the group has a hydrogen atom, the hydrogen atom may be substituted with a substituent; L²³ represents a bivalent linking group selected from —O—, —S—, —C(═O)—, —SO₂—, —NH—, —CH₂—, —CH═CH— and —C≡C—, and a group formed by linking two or more of these, provided that, when the group has a hydrogen atom, the hydrogen atom may be substituted with a substituent; and Q¹ represents a polymerizing group or a hydrogen atom.
[8] The retardation film as set froth in any one of [1] to [7], wherein the optically-anisotropic layer comprises at least one fluoroaliphatic group-containing polymer.
[9] The retardation film as set forth in any one of [1] to [8], wherein thickness-direction retardation at a wavelength of 550 nm of the polymer film, Rth(550), is equal to or more than 30 nm.
[10] The retardation film as set forth in any one of [1] to [9], wherein the polymer film is a cellulose acylate film.
[11] A polarizing plate comprising at least a polarizing film and a retardation film as set forth in any one of [1] to [10].
[12] A liquid-crystal display device comprising a retardation film as set forth in any one of [1] to [11] as a first retardation film.
[13] The liquid-crystal display device as set forth in [12] comprising:

a pair of polarizing films with their absorption axes being perpendicular to each other,

a pair of substrates disposed between the pair of polarizing films, and

a liquid crystal layer of liquid-crystal molecules sandwiched between the substrates, in which the liquid-crystal molecules are aligned substantially vertically to the substrates in OFF state with no external electric field applied thereto.
[14] The liquid-crystal display device of [13], which further comprises a second retardation film formed of a polymer stretched film.
[15] The liquid-crystal display device of [14], comprising a retardation film as set forth in [1] as the first retardation film, wherein in-plane retardation at a wavelength of 550 nm of the second retardation film, Re(550), and thickness-direction retardation at the same wavelength thereof, Rth(550), satisfy the following formula (3-1) and (4-1):

70 nm≦Re(550)≦210 nm (3-1)

−0.6<Rth(550)/Re(550)≦−0.4 (4-1).
[16] The liquid-crystal display device of [14], comprising a retardation film as set forth in [2] as the second retardation film, wherein in-plane retardation at a wavelength of 550 nm of the second retardation film, Re(550), and the Nz value, Nz=Rth(550) /Re(550)+0.5, at the same wavelength satisfy the following formula (3-2) and (4-2):

200 nm≦Re(550)≦300 nm (3-2)

0.3<Nz<0.7 (4-2).
[17] The liquid-crystal display device of [14], comprising a retardation film as set forth in [2] as the second retardation film, wherein in-plane retardation at a wavelength of 550 nm of the second retardation film, Re(550), and the Nz value, Nz=Rth(550) /Re(550)+0.5, at the same wavelength satisfy the following formula (5-2) and (6-2):

240 nm≦Re(550)≦290 nm (5-2)

0.4<Nz<0.6 (6-2).
[18] The liquid-crystal display device of [14], comprising a retardation film as set forth in [2] as the second retardation film, wherein the second retardation film satisfies the following formula (7-2):

0.7≦Re(450)/Re(550)≦1.1 (7-2).
[19] The liquid-crystal display device as set forth in any one of [14] to [18], wherein the second retardation film is any of a cellulose acylate film, a norbornene film, a polycarbonate film, a polyester film and a polysulfone film.
[20] The liquid-crystal display device as set forth in any one of [14] to [19], wherein the second retardation film is directly laminated on one of the pair of polarizing films so that its in-plane slow axis is perpendicular to the absorption axis of the polarizing film.

### BRIEF DESCRIPTION OF THE DRAWINGS

FIG. 1 is a schematic view showing the constitution of an embodiment of the liquid-crystal display device of the first aspect of the invention.

FIG. 2 is a schematic view showing the constitution of another embodiment of the liquid-crystal display device of the first aspect of the invention.

FIG. 3 is a schematic view showing the constitution of another embodiment of the liquid-crystal display device of the first aspect of the invention.

FIG. 4 is a view showing one example of the trace of the polarized state of the incident light to the embodiment of the liquid-crystal display device of FIG. 1, on a Poincare sphere.

FIG. 5 is a schematic view showing the constitution of an embodiment of the liquid-crystal display device of the second aspect of the invention.

FIG. 6 is a schematic view showing the constitution of another embodiment of the liquid-crystal display device of the second aspect of the invention.

FIG. 7 is a schematic view showing the constitution of another embodiment of the liquid-crystal display device of the second aspect of the invention.

FIG. 8 is a schematic view showing the constitution of another embodiment of the liquid-crystal display device of the second aspect of the invention.

FIG. 9 is a schematic view showing the constitution of another embodiment of the liquid-crystal display device of the second aspect of the invention.
FIG. 10 is a view showing one example of the trace of the polarized state of the incident light to the embodiment of the liquid-crystal display device of FIG. 8, on a Poincare sphere.

In the drawings, the reference numerals have the following meanings:
1 Protective film for first polarizing film (outer side)
2 Absorption axis direction of first polarizing film
3 First polarizing film
4 Protective film for first polarizing film (cell side)
6 Liquid-crystal cell
7 Protective film for second polarizing film (cell side)
8 Second polarizing film
9 Absorption axis direction of second polarizing film
10 Protective film for second polarizing film (outer side)
11 First retardation film (retardation film of the first aspect of the invention)
12 Second retardation film (negative A-plate)
13 Slow axis direction of second retardation film (negative A-plate)
21 First retardation film (retardation film of the second aspect of the invention)
22 Second retardation film (biaxial film)
23 Slow axis direction of second retardation film (biaxial film)

### PREFERRED EMBODIMENT OF THE INVENTION

The invention will be described in detail below. The expression “from a lower value to an upper value” referred herein means that the range intended by the expression includes both the lower value and the upper value.

In the description, regarding values or ranges relating to optical properties, a certain error margin is acceptable in terms of common sense in the related art as far as the effect of the invention can be obtained.

In the description, regarding angles between two axes, such as “45°”, “parallel” and “perpendicular”, a certain error margin is acceptable in terms of manufacturing as far as the effect of the invention can be obtained. In general, the error margin may be within ±5°, preferably within ±4°, and more preferably within ±3°. In the description, regarding angles, regarding angles, “+” means clockwise rotation, and “−” means anti-clockwise rotation. In the description, “Slow axis” means the direction in which the refractive index is the largest; and “visible light region” means from 380 to 780 nm.

In the description, when there is no notation regarding the measurement wavelength, the measurement wavelength for Re or Rth is 550 nm.

In the description, “polarizing element (or polarizing film)” is differentiated from “polarizing plate”. “Polarizing plate” is meant to indicate a laminate that comprises a “polarizing element” and, as formed on at least one surface thereof, a transparent protective film to protect the polarizing element.

In the description, the term “polarizing plate” is used for both of long-web polarizing plates and those cut (“cutting” in this description includes “punching” and “clipping”) into size suitable for incorporation into liquid crystal devices.

In the description, Re(λ) and Rth(λ) each indicate in-plane retardation (unit:nm) and the thickness direction retardation (unit:nm) at a wavelength λ. Re(λ) is measured by applying a light having a wavelength of λ nm in the normal line direction of a sample such as a film, using KOBRA-21ADH or WR (by Oji Scientific Instruments). Selection of wavelength for measuring may be performed by manual change of a wavelength-selection filter or by programming conversion of measured data.

When the sample to be tested is represented by an uniaxial or biaxial refractive index ellipsoid, then its Rth(λ) is calculated according to the method mentioned below.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the in-plane slow axis from the normal line direction taken as the rotation axis thereof, when the sample has a zero retardation value at a certain inclination angle, then the symbol of the retardation value of the sample at an inclination angle larger than that inclination angle is changed to a negative one, and then applied to KOBRA 21ADH or WR for computation.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (I) and (II):

(I):

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}}$$

Rth={(nx+ny)/2−nz}×d (II):

wherein Re(θ) means the retardation value of the sample in the direction inclined by an angle θ from the normal line direction; nx means the in-plane refractive index of the sample in the slow axis direction; ny means the in-plane refractive index of the sample in the direction vertical to nx; nz means the refractive index of the sample vertical to nx and ny; and d is a thickness of the sample.

When the sample to be tested can not be represented by a monoaxial or biaxial index ellipsoid, or that is, when the sample does not have an optical axis, then its Rth(λ) may be calculated according to the method mentioned below.

With the in-plane slow axis (determined by KOBRA 21ADH or WR) taken as the inclination axis (rotation axis) of the sample, Re(λ) of the sample is measured at 11 points in all thereof, from −50° to +50° relative to the normal line direction of the sample at intervals of 10°, by applying a light having a wavelength of λ nm from the inclined direction of the sample. Based on the thus-determined retardation data of Re(λ), the mean refractive index and the inputted thickness of the sample, Rth(λ) of the sample is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

The invention relates to a retardation film comprising a polymer film, and, disposed thereon, at least, one optically-anisotropic layer, of which in-plane retardation, Re(550), thickness-direction retardation, Rth(550) and wavelength dispersion characteristics of thickness-direction retardation Rth(450)/Rth(550) each fall within a predetermined range. The retardation film of the invention is, when applied to a liquid-crystal display device, contributes toward reduction in the color shift occurring in oblique directions.

More concretely, use of the retardation film of the invention for optical compensation, use of the retardation film of the first aspect of the invention for optical compensation as combined with a negative A-plate, or use of the retardation film of the second aspect of the invention for optical compensation as combined with a biaxial film may reduce the color shift especially in VA-mode liquid-crystal display devices.

The retardation films of the first and second aspects of the invention are described below.

### 1. Retardation Film of First Aspect of the Invention:

The retardation film of the first aspect of the invention comprises a polymer film, and, disposed thereon, at least one optically-anisotropic layer. In-plane retardation Re of the retardation film is from 0 to 10 nm, preferably from 0 to 5 nm, more preferably from 0 to 3 nm. Its thickness-direction retardation Rth is from 200 to 450 nm, more preferably from 230 to 450 nm, even more preferably from 250 to 400 nm. In the embodiment where the retardation film is used as a retardation film in VA-mode liquid-crystal display devices, the wavelength dispersion characteristics of the retardation of the retardation film, Rth(450) /Rth(550) is from 1.00 to 1.07, more preferably from 1.00 to 1.06, even more preferably from 1.00 to 1.05, still more preferably from 1.01 to 1.04. When the retardation film satisfies the above-mentioned wavelength dispersion characteristics of retardation, then it may be usable for compensation in VA-mode liquid-crystal display devices in the entire visible light range. Preferably, the retardation film of this embodiment is combined with a negative A-plate.

### 2. Retardation Film of Second Aspect of the Invention:

The retardation film of the second aspect of the invention comprises a polymer film, and, disposed thereon, at least one optically-anisotropic layer. In-plane retardation Re of the retardation film is from 0 to 10 nm, preferably from 0 to 5 nm, more preferably from 0 to 3 nm. Its thickness-direction retardation Rth is from 200 to 400 nm, more preferably from 230 to 370 nm, even more preferably from 250 to 350 nm. In the embodiment where the retardation film is used as a retardation film in VA-mode liquid-crystal display devices, the wavelength dispersion characteristics of the retardation of the retardation film, Rth(450)/Rth(550) is preferably from 1.04 to 1.09, more preferably from 1.05 to 1.08, even more preferably from 1.06 to 1.08. In this, Rth(450) means the Rth value to light having a wavelength of 450 nm; and Rth(550) means the Rth value to light having a wavelength of 550 nm. When the retardation film satisfies the above-mentioned wavelength dispersion characteristics of retardation, then it may be usable for compensation in VA-mode liquid-crystal display devices in an entire visible light range. Preferably, the retardation film of this embodiment is combined with a biaxial film.

### 3. Details of Retardation Film of the Invention:

The polymer film and the optically-anisotropic layer for the retardation film of the invention are described in detail hereinunder.

### 3.-1 Polymer Film:

Preferably, the polymer film, that the retardation films of the above-mentioned first and second aspects have therein, satisfies the following formulae (11) to (13):

30 nm≦Rth(550)≦250 nm (11)

Rth(450)/Rth(550)≦1.06 (12)

0<Re(550)≦10 nm (13)

In formula (11), Rth(550) is preferably equal to or more than 30 nm, more preferably equal to or more than 60 nm, even more preferably equal to or more than 80 nm. When thickness-direction retardation of the polymer film is large, then the optically-anisotropic layer may be thinned, and there hardly occurs a problem of coating unevenness. The uppermost limit of Rth(550) is not specifically defined. In general, the uppermost limit of Rth of the polymer film is 250 nm or so.

In formula (12), [Rth(450)/Rth(550)] is preferably equal to or less than 1.05, more preferably equal to or less than 1.03, even more preferably equal to or less than 1.00. [Rth(450)/Rth(550)] is preferably equal to or less than 0.70.

In formula (13), Re(590) is preferably from 0 to 5 nm.

The thickness of the polymer film may be decided depending on retardation thereof; and, in terms of thinning and workability, preferably, the thickness of the polymer film is from 10 to 150 μm, more preferably from 20 to 130 μm, and much more preferably from 30 to 100 μm.

The material of the polymer film is not specifically defined, for which are usable polymer films of various materials satisfying the above-mentioned optical properties. Above all, preferred are cellulose acylate films as their materials are inexpensive and they have good workability into polarizing plates. In this description, “cellulose acylate films” as referred to in this description mean that the main ingredient of the polymer composition constituting the film, concretely, the cellulose acylate relative to the overall mass of the film is, for example, at least 70% by mass, preferably at least 80% by mass. In this description, the wording “mainly comprising” and the wording “main ingredient” shall have the same meaning.

A commercial cellulose acylate film (for example, FUJI FILM's TD80UF) may be, directly as it is or after heated and stretched, formed into a cellulose acylate film satisfying the above formulae (11) to (13). A dope prepared by adding a retardation enhancer such as a 1,3,5-triazine ring compound to a solution of cellulose acylate having a degree of acetylation of from 55.0 to 62.5% or so may be cast onto a drum or the like to form thereon a cellulose acylate film satisfying the above formulae (11) to (13). Retarding the condition for the dope casting method, the retardation enhancer and the cellulose acylate material that are usable in the methods described below, detailed descriptions are given, for example, in JP-A 2001-166144, and are referred to for the formation of the polymer films.

Cellulose acylate is a cellulose derivative in which a part of or all of hydroxy groups are substituted with an acyl group. The degree of substitution of cellulose acylate means the degree of acylation of three hydroxyl groups existing in the constitutive unit ((β)1,4-glycoside-bonding glucose) of cellulose. The degree of substitution (degree of acylation) may be computed by measuring the bonding fatty acid amount per the constitutive unit mass of cellulose. The determination may be carried out according to “ASTM D817-91”.

Preferably, the cellulose acylate is selected from cellulose acetates having a degree of acetyl substitution of from 2.90 to 3.00. More preferably, the degree of acetyl substitution is from 2.93 to 2.97.

Other preferable examples of the material of the polymer film include cellulose ester derivatives of mixed fatty acids of which total acylation degree is from 2.70 to 3.00. Cellulose ester derivatives, having a C₃₋₄ acyl group, of mixed fatty acids of which total acylation degree is from 2.80 to 3.00, are more preferable. The total acylation degree of the cellulose ester derivatives of mixed fatty acids is even more preferably from 2.85 to 2.97. The substitution degree with C₃₋₄ acyl group is preferably from 0.1 to 2.0, and more preferably from 0.3 to 1.5.

Preferably, the cellulose acylate has a mass-average degree of polymerization of from 350 to 800, more preferably from 370 to 600. Also preferably, the cellulose acylate for use in the invention has a number-average molecular weight of from 70,000 to 230,000, more preferably from 75,000 to 230,000, even more preferably from 78,000 to 120,000.

The cellulose acylate may be produced, using an acid anhydride or an acid chloride as an acylation agent for it. Using an acid hydride as an acylation agent, organic acid such as acetic acid or methylene chloride may be used as reaction solvent. Protic catalysts such as sulfuric acid may be used as catalyst. Using an acid chloride as an acylation agent, basic catalysts may be used as catalyst. One most general production method for producing the cellulose acylate on an industrial scale comprises esterifying cellulose obtained from cotton linter, wood pulp or the like with a mixed organic acid component comprising an organic acid corresponding to an acetyl group and other acyl group (acetic acid, propionic acid, butyric acid) or its acid anhydride (acetic anhydride, propionic anhydride, butyric anhydride).

According to this process, before being esterified, in general, cellulose obtained from cotton linter and wood pulp is subjected to an activation treatment with organic acid such as acetic acid. Acid anhydride may be used in excess compared with the amount of hydroxy groups in cellulose. According to the esterification, the hydrolysis, or in other words depolymerization reaction, of β1→4 glycoside bonds in cellulose major chain may be carried out while the esterification is carried out. When the hydrolysis of the main chain is carried out, the polymerization degree of cellulose acylate is decreased and therefore properties of a cellulose acylate film made of it maybe lowered. The reaction conditions such as reaction temperature may reflect the preferable polymerization degree and/or molecular weight of cellulose acylate.

The polymer films, satisfying the formulas (11) to (13), may be prepared from commercially available films, such as “TD80UF” manufactured by FUJIFILM, directly or by being subjected to a heat treatment. The polymer films may also be prepared as follows. A dope is prepared by adding a retardation enhancer such as 1,3,5-triazine ring compound to a solution of cellulose acylate having a acylation degree of 55.0 to 62.5% around, and cast on a drum to form a cellulose acylate film satisfying the formulas (11) to (13). The conditions of the solvent casting method, examples of the retardation enhancer and cellulose acylate materials, which are described in JPA No. 2001-166144 in detail, may be employed in the method for preparing the polymer.

### 3.-2 Optically-Anisotropic Layer:

The wavelength dispersion characteristics of retardation, Rth(450)/Rth(500) of the optically-anisotropic layer that the retardation films of the first and second aspects have therein is preferably from 1.05 to 1.15, more preferably from 1.06 to 1.14, even more preferably from 1.07 to 1.13. When the layer has the wavelength dispersion characteristics of retardation falling within the range, then the retardation film may have good wavelength dispersion characteristics of retardation, as combined with the wavelength dispersion characteristics of retardation of the polymer film therein, and therefore, the retardation film may compensate liquid-crystal display devices in the entire visible light range. Preferably, in-plane retardation Re of the optically-anisotropic layer is from 0 to 10 nm, more preferably from 0 to 5 nm.

In addition, the value, Rth/d, obtained by dividing thickness-direction retardation Rth of the optically-anisotropic layer by the thickness d of the optically-anisotropic layer is preferably equal to or more than 0.080, more preferably equal to or more than 0.090, and even more preferably equal to more than 0.10. The optically-anisotropic layer satisfying the condition is advantageous in that it may be free from a problem of coating unevenness in a coating process of continuously forming it on a long support. Using a liquid-crystal compound having excellent Rth expressibility, in particular, a liquid-crystal compound represented by a general formula (DI) to be mentioned below facilitates the formation of the optically-anisotropic layer having Rth/d of at least 0.080. Not specifically defined, the uppermost limit of Rth/d may be generally at most 0.20.

### 3.-2-1 Optically-Anisotropic Layer of Polymerizable Composition:

Preferably, the optically-anisotropic layer is formed of a polymerizable composition, more preferably a composition that comprises a liquid-crystal compound having an optically-negative refractivity anisotropy and having a polymerizable group(s). Examples of such the optically-anisotropic layer include a layer formed of a polymerizable composition that comprises a chiral nematic (cholesteric) liquid-crystal compound, and a layer, in which the discotic liquid-crystal-derived discotic structure units are aligned horizontally to the layer face, formed of a composition that comprises discotic liquid-crystal compound.

The chiral nematic (cholesteric) liquid-crystal compound means a compound that forms a chiral nematic (cholesteric) liquid-crystal phase when the compound-containing composition is applied on a polymer substrate, and examples of such the compound include rod-like liquid-crystal compounds and polymer liquid-crystal compounds.

For chiral nematic (cholesteric) alignment of rod-like liquid-crystal compound, used is an optically-active rod-like liquid-crystal compound or a mixture of a rod-like liquid-crystal compound and an optically-active compound. Preferable examples of the rod-like liquid crystal compound include azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans and alkenyl cyclohexyl benzonitriles.

A composition containing the compound is applied to a surface of a polymer film support, and then fixed thereon with keeping the alignment state as such in the same manner as in the formation of an optically-anisotropic layer of a discotic liquid-crystal compound to be mentioned hereinunder.

The optically-anisotropic layer may also be formed of a polymer material that has, when formed by coating, negative refractivity anisotropy and has an optical axis in the normal line direction of the film surface. The polymer material may be a film-forming material having at least one aromatic ring, as proposed in JPA No. 2000-190385 (various polymers such as polyamide, polyimide, polyamic acid, polyester, polyesteramide, and polymerizable low-molecular compounds capable of forming such polymers). When applied onto a support by coating, the layer of the material has negative refractivity anisotropy and has an optical axis in the normal line direction of the layer face, generally having regular wavelength dispersion characteristics of retardation.

### 3.-2-2 Optically-Anisotropic Layer of Discotic Liquid Crystal Composition:

According to the invention, the optically anisotropic layer is preferably formed of a composition containing at least one discotic liquid crystal compound. Examples of the discotic liquid-crystal compound include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehnetal. and “J. Am. Chem. Soc.”, vol. 116, page 2,655 (1994), J. Zhang et al. The polymerization of discotic liquid-crystal compounds is described, for example, in JPA No. Hei 8-27284 (1996-27284).

In order to immobilize discotic liquid crystalline molecules by a polymerization, the discotic liquid crystal compounds having at least one polymerizable group(s) are preferable. For example, a polymerizable group may be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Examples of the discotic liquid crystal compound having at least one polymerizable group include the compounds represented by formula (VI) below.

D(−L−P)ₙ (VI)

In the formula, D is a disk-shaped core, L is a divalent liking group, P is a polymerizable group and n is an integer from 2 to 12.

In the formula, examples of the disk-shaped core, D, the linking group, L, and the polymerizable group, P, include (D1) to (D15), (L1) to (L25) and (P1) to (P18) described in JPA No. 2001-4837.

The discotic liquid crystal compound having at least one polymerizable group may be aligned horizontally, as described above. Preferable examples of such discotic liquid crystal compound also include the examples described in WO01/88574A1, from p. 58, 1.6 to p. 65, 1.8.

According to the invention, the discotic compound is preferably selected from the compounds represented by formula (DI).

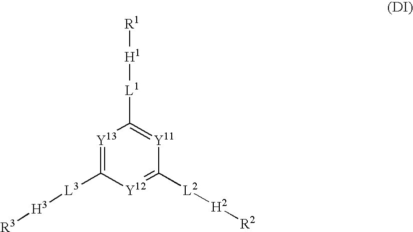

In formula (DI), Y¹¹, Y¹² and Y¹³ each independently represent a methine group or a nitrogen atom. When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group.

Of those, preferred are an alkyl group, an alkoxy group, an alkoxycarbonyl group, an acyloxy group, a halogen atom and a cyano group; more preferred are an alkyl group having from 1 to 12 carbon atoms (the term “carbon atoms” means hydrocarbons in a substituent, and the terms appearing in the description of the substituent of the discotic liquid crystal compound have the same meaning), an alkoxy group having from 1 to 12 carbon atoms, an alkoxycarbonyl group having from 2 to 12 carbon atoms, an acyloxy group having from 2 to 12 carbon atoms, a halogen atom and cyano.

Preferably, Y¹¹, Y¹² and Y¹³ are all methine groups, more preferably non-substituted methine groups.

In formula (DI), L¹, L² and L³ each independently represent a single bond or a bivalent linking group. The bivalent linking group is preferably selected from —O—, —S—, —C(═O)—, —NR⁷—, —CH═CH—, —C≡C—, a bivalent cyclic group, and their combinations.

R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, even more preferably a 6-membered group. The ring in the cyclic group may be a condensed ring. However, a monocyclic ring is preferred to a condensed ring for it.

The ring in the cyclic ring may be any of an aromatic ring, an aliphatic ring, or a hetero ring. Examples of the aromatic ring are a benzene ring and a naphthalene ring. An example of the aliphatic ring is a cyclohexane ring. Examples of the hetero ring are a pyridine ring and a pyrimidine ring.

Preferably, the cyclic group contains an aromatic ring or a hetero ring. Preferably, the cyclic group is a linking group consisting of a cyclic structure, optionally having at least one substituent.

Of the bivalent cyclic group, the benzene ring-having cyclic group is preferably a 1,4-phenylene group.

The naphthalene ring-having cyclic group is preferably a naphthalene-1,5-diyl group or a naphthalene-2,6-diyl group.

The cyclohexane ring-having cyclic group is preferably a 1,4-cyclohexylene-diyl group.

The pyridine ring-having cyclic group is preferably a pyridine-2,5-diyl group.

The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *—C≡C—, *-“bivalent cyclic group”-, *—O—CO— “bivalent cyclic group”-, *—CO—O— “bivalent cyclic group”-, *—CH═CH— “bivalent cyclic group”-, *—C≡C— “bivalent cyclic group”-, *-“bivalent cyclic group” —O—CO—, *-“bivalent cyclic group” —CO—O—, *-“bivalent cyclic group” —CH═CH—, or *-“bivalent cyclic group” —C≡C—.

More preferably, they are a single bond, *—CH═CH—, *—C≡C—, *—CH═CH— “bivalent cyclic group”- or *—C≡C— “bivalent cyclic group”-, even more preferably a single bond.

In the examples, “*” indicates the position at which the group bonds to the 6-membered ring of formula (DI) that contains Y¹¹, Y¹² and Y³.

In formula (DI), H¹, H² and H³ each independently represent the following formula (DI-A) or (DI-B):

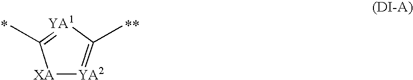

In formula (DI-A), YA¹ and YA each independently represent a methine group or a nitrogen atom. Preferably, at least one of YA¹ and YA² is a nitrogen atom, more preferably they are both nitrogen atoms. XA represents an oxygen atom, a sulfur atom, a methylene group or an imino group. XA is preferably an oxygen atom.

It is to be noted that * indicates the position at which the formula bonds to any of L¹ to L³; and ** indicates the position at which the formula bonds to any of R¹ to R³, and that “imino” means —NH— (or the group in which H is substituted with any substituent).

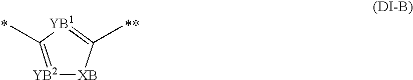

In formula (DI-B), YB¹ and YB² each independently represent a methine group or a nitrogen atom. Preferably, at least one of YB¹ and YB² is a nitrogen atom, more preferably they are both nitrogen atoms.

XB represents an oxygen atom, a sulfur atom, a methylene group or an imino group. XB is preferably an oxygen atom.

* indicates the position at which the formula bonds to any of L¹ to L³; and ** indicates the position at which the formula bonds to any of R¹ to R³.

In the formula, R¹, R² and R³ each independently represent the following formula (DI-R):

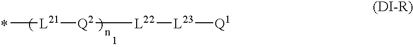

In formula (DI-R), * indicates the position at which the formula bonds to H¹, H² or H in formula (DI).

In the formula, L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, ***—O—CO—, ***—CO—O—, ***—CH═CH— or ***-C≡C— (in which *** indicates the left side of L²¹ in formula (DI-R)). More preferably it is a single bond.

In the formula, Q² represents a bivalent linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it.

The ring in the cyclic ring may be any of an aromatic ring, an aliphatic ring, or a hetero ring. Examples of the aromatic ring are a benzene ring, a naphthalene ring, an anthracene ring, a phenanthrene ring.

An example of the aliphatic ring is a cyclohexane ring.

Examples of the hetero ring are a pyridine ring and a pyrimidine ring.

Preferably, the cyclic group contains an aromatic ring or a hetero ring. Preferably, the cyclic group is a divalent linking group consisting of a cyclic structure, optionally having at least one substituent.

In the formula, the benzene ring-having group for Q² is preferably a 1,4-phenylene group.

The naphthalene ring-having group for Q² is preferably a naphthalene-1,5-diyl group and a naphthalene-2,6-diyl group.

The cyclohexane ring-having group for Q² is preferably a 1,4-cyclohexylene group.

The pyridine ring-having group for Q² is preferably a pyridine-2,5-diyl group.

The pyrimidine ring-having group for Q² is preferably a pyrimidin-2,5-diyl group.

More preferably, Q² is a 1,4-phenylene group or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

Preferable examples of the substituent include a halogen atom, a cyano group, an alkyl group having from 1 to 6 carbon atoms, and a halogen atom-substituted alkyl group having from 1 to 6 carbon atoms; more preferable examples include a halogen atom, an alkyl group having from 1 to 4 carbon atoms, and a halogen atom-substituted alkyl group having from 1 to 4 carbon atoms; even more preferable examples include a halogen atom, an alkyl group having from 1 to 3 carbon atoms, and a trifluoromethyl group.

In the formula, n1 indicates an integer of from 0 to 4. n1 is preferably an integer of from 1 to 3, more preferably 1 or 2.

In the formula, L²² represents **—O—, **—O—CO—, **—CO—O—, **—O—CO—O—, **—S—, **—NH—, **—SO₂—, **—CH₂—, **—CH═CH— or **—C≡C— in which ** indicates the side bonding to Q² side), preferably **—O—, **—O—CO—, **—CO—O—, **—O—CO—O—, **—CH₂—, **—CH═CH— or **—C═C—, and more preferably **—O—, **—O—CO—, **—CO—O—, **—O—CO—O—, or **—CH₂—.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ is preferably a linking group selected from a group consisting of —O—, —C(═O)—, —CH₂—, —CH═CH— and —C≡C—, and a group formed by linking two or more of these.

L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizing group or a hydrogen atom. In case where the compound of formula (DI) is used in producing optical films of which the retardation is required not to change by heat, such as optical compensatory films, Q¹ is preferably a polymerizing group. The polymerization for the group is preferably addition polymerization (including ring-cleavage polymerization) or polycondensation. In other words, the polymerizing group preferably has a functional group that enables addition polymerization or polycondensation. Examples of the polymerizing group are shown below.

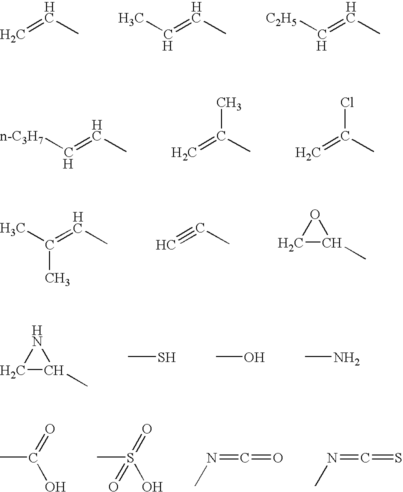

More preferably, the polymerizing group is addition-polymerizing functional group. The polymerizing group of the type is preferably a polymerizing ethylenic unsaturated group or a ring-cleavage polymerizing group.

Examples of the polymerizing ethylenic unsaturated group are the following (M-1) to (M-6):

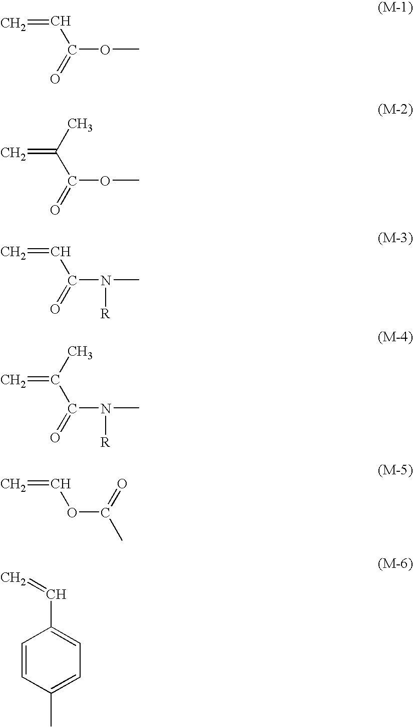

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizing group is preferably a cyclic ether group, more preferably an epoxy group or an oxetanyl group, most preferably an epoxy group.

A liquid-crystal compound of the following formula (DII) is more preferred for the liquid-crystal compound for use in the invention.

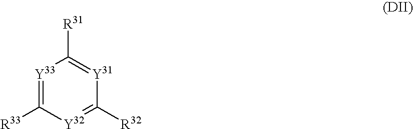

In formula (DII), Y³¹, Y³² and Y³³ each independently represent a methine group or a nitrogen atom. Y³¹, Y³² and Y³³ have the same meaning as that of Y¹¹, Y¹² and Y¹³ in formula (DI), and their preferred range is also the same as therein.

In the formula, R³¹, R³² and R³³ each independently represent the following formula (DII-R):

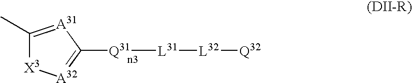

In formula (DII-R), A³¹ and A³² each independently represent a methine group or a nitrogen atom. Preferably, at least one of A³¹ and A³² is a nitrogen atom; most preferably the two are both nitrogen atoms. In the formula, X³ represents an oxygen atom, a sulfur atom, a methylene group or an imino group. Preferably, X³ is an oxygen atom.

In formula (DII-R), Q³¹ represents a bivalent cyclic linking group having a 6-membered cyclic structure.

The 6-membered ring in F² may be a condensed ring. However, a monocyclic ring is preferred to a condensed ring for it.

The 6-membered ring in Q³¹ may be any of an aromatic ring, an aliphatic ring, or a hetero ring. Examples of the aromatic ring are a benzene ring, a naphthalene ring, an anthracene ring and a phenanthrene ring.

An example of the aliphatic ring is a cyclohexane ring.

Examples of the hetero ring are a pyridine ring and a pyrimidine ring.

Preferably, the cyclic group contains an aromatic ring or a hetero ring. Preferably, the cyclic group is a divalent linking group consisting of a cyclic structure, optionally having at least one substituent.

In the formula, the benzene ring-having group for Q³¹ is preferably a 1,4-phenylene group or a 1,3-phenylene group.

The naphthalene ring-having group for Q³¹ is preferably a naphthalene-1,5-diyl group and a naphthalene-2,6-diyl group.

The cyclohexane ring-having group for Q³¹ is preferably a 1,4-cyclohexylene group.

The pyridine ring-having group for Q³¹ is preferably a pyridine-2,5-diyl group.

The pyrimidine ring-having group for Q³¹ is preferably a pyrimidin-2,5-diyl group.

More preferably, Q³¹ is a 1,4-phenylene group or a 1,3-phenylene group.

In the formula, Q³¹ may have at lease one substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

The substituent of the bivalent cyclic group is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n3 indicates an integer of from 1 to 3. n3 is preferably 1 or 2.

In the formula, L³¹ represents *—O—, *—O—CO—, *—CO—O—, *—O—CO—O—, *—S—, *—N(R)—, *—SO₂—, *—CH₂—, *—CH═CH— or *—C≡C— (in which “*” indicates the site bonding to the Q³¹ side), and has the same meaning as that of L²² in formula (DI-R). The preferred range of L³¹ may be the same as that of L²² in formula (DI-R).

In the formula, L³² represents a bivalent linking group selected from —O—, —S—, —C(═O)—, —SO₂—, —NH—, —CH₂—, —CH═CH— and —C≡C—, and a group formed by linking two or more of these, and when the group has a hydrogen atom, the hydrogen atom may be substituted with a substituent, and has the same meaning as that of L²³ in formula (DI-R). The preferred range of L³² may be the same as that of L²³ in formula (DI-R).

In the formula, Q³² represents a polymerizing group or a hydrogen atom, and has the same meaning as that of Q¹ in formula (DI-R). And its preferred range is the same as that of Q¹ in formula (DI-R).

Examples of the compound represented by formula (DI), but are not limited to, those shown below.

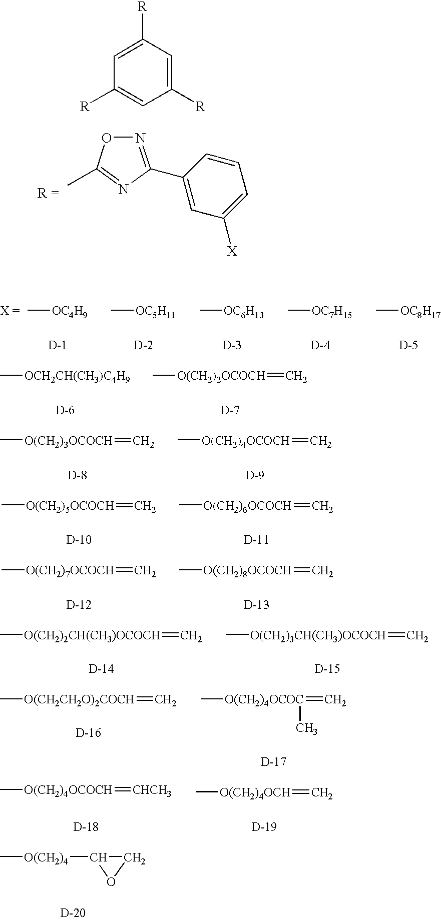

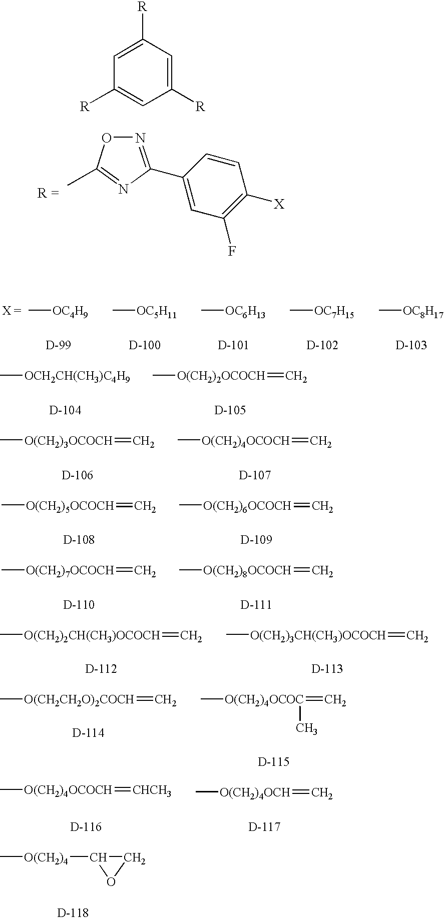

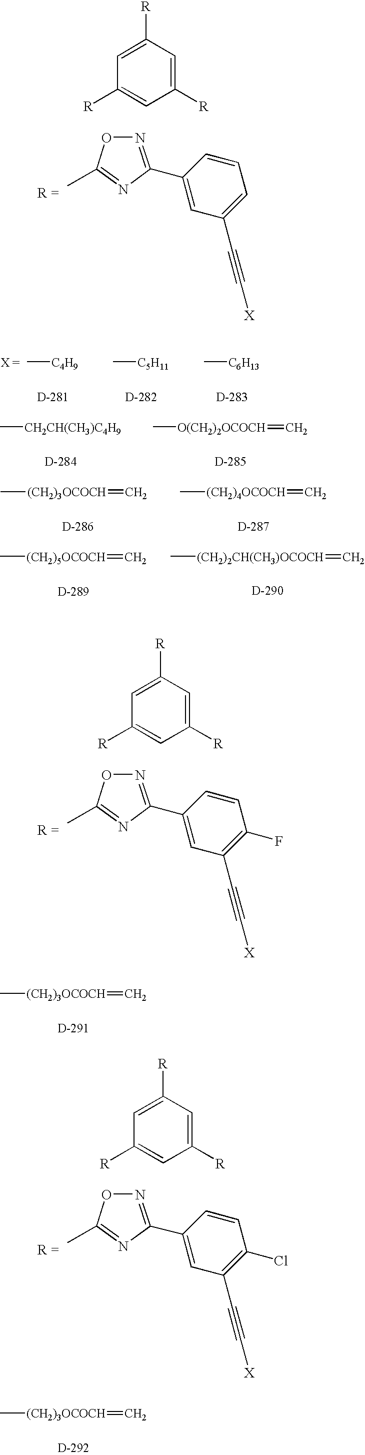

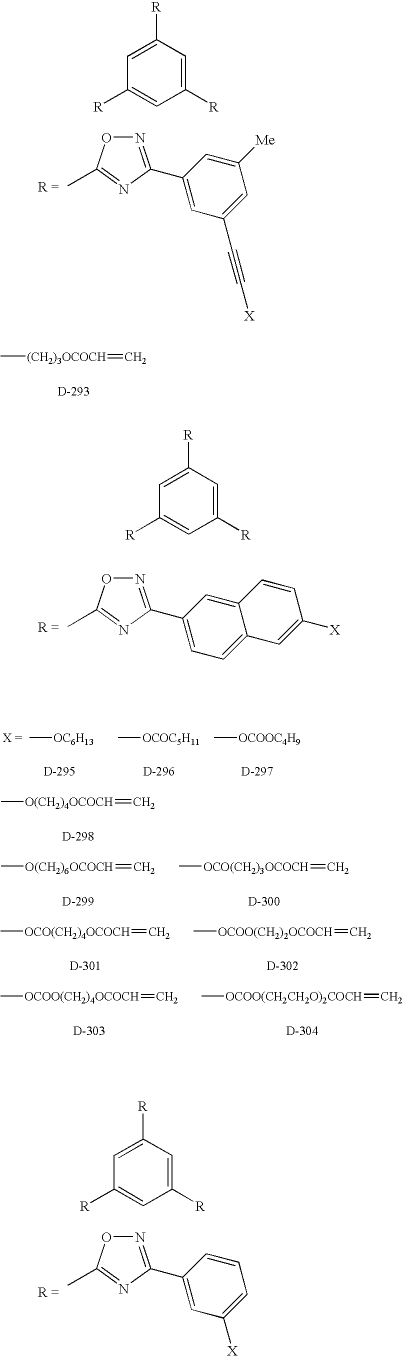

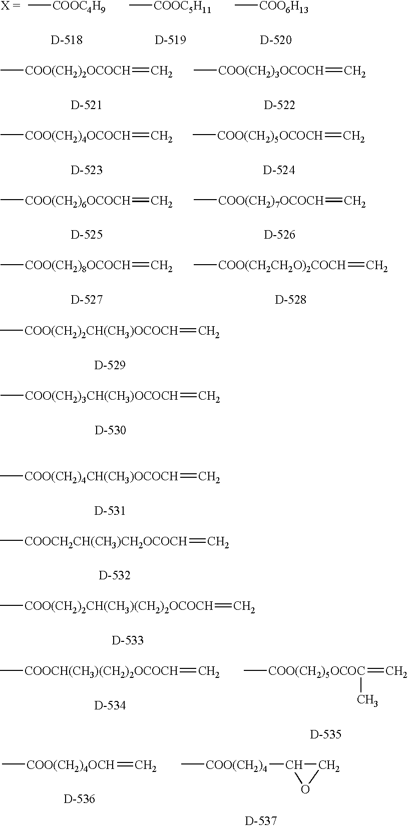

The liquid crystal compound to be used in the invention preferably expresses a liquid crystal phase having a good monodomain property. If a liquid crystal phase contains polydomains, alignment defects may be occurred at the interfaces among the polydomains, and such defects may cause light scattering. Therefore, use of a liquid crystal compound, expressing a liquid crystal phase having a good monodomain property, is helpful for preventing such light scattering. Furthermore, use of such a liquid crystal compound may contribute to increasing the light transmittance of the retardation film prepared therefrom.

Examples of the liquid-crystal phase, that the liquid-crystal compound of the invention expresses, include a columnar phase and a discotic nematic phase (ND phase). Of those liquid-crystal phases, preferred is a discotic nematic phase (ND phase) since it has a good monodomain property and it can be aligned in a hybrid alignment sate.

According to the invention, the liquid crystal compound having smaller wavelength dispersion characteristics of anisotropy is more preferable. In particular, Re(450)/Re(650) of the optically anisotropic layer is preferably less than 1.25, more preferably equal to or less than 1.20, and even more preferably equal to or less than 1.15. The thickness of the optically anisotropic layer is preferably equal to or less than 5 μm. For reducing unevenness and improving smoothness, the thickness is more preferably from 0.5 to 4.0 μm. The compound represented by formula (DI) is excellent in expressing Rth, and the optically anisotropic layer prepared by using the compound has the high Rth value even if the thickness of the layer is very small as mentioned above.

For aligning the liquid crystal compound on a polymer film (or an alignment layer optionally formed thereon), the transition temperature to an isotropic phase, Tᵢₛₒ, is preferably form 100 to 180° C., more preferably from 100 to 165° C., and even more preferably from 100 to 150° C.

The optically-anisotropic layer may be formed as follows. A curable liquid crystal composition, comprising at least the liquid crystal compound, may be applied to a surface of a polymer film or an alignment film optionally formed thereon, aligned on the surface, and irradiated with UV light to carry out the curing reaction. And the alignment state is cured, and then, the optically anisotropic layer is obtained. For improving the coating property and/or promoting alignment of the liquid crystal compound, at least one additive may be added to the curable liquid crystal composition. Fluoro-aliphatic group-containing polymers are preferable since both effects are obtainable. Examples of such polymer include polymers described in JPA No. 2006-267183.

### 4. Polarizing Plate:

The invention also relates to a polarizing plate comprising a polarizing film and the retardation film of the invention (retardation film of the first or second aspects).

In the polarizing plate of the invention, the retardation film is preferably stuck to the surface of the polarizing film with an adhesive. More concretely, the back face of the polymer film of the retardation film (on the side not coated with an optically-anisotropic layer) is preferably stuck to the surface of the polarizing film with an adhesive. In case where any other polymer film or the like is disposed between the polarizing film and the retardation film, the film is preferably optically isotropic.

The films are preferably stuck together with an adhesive. Not specifically defined, the adhesive may be a PVA resin (including modified PVA with acetoacetyl group, sulfonic acid group, carboxyl group, oxyalkylene group or the like), or an aqueous solution of a boron compound. Above all, preferred is a PVA resin.

The thickness of the adhesive layer is, after dried, preferably from 0.01 to 10 μm, more preferably from 0.05 to 5 μm.

The sticking may be attained with holding both edges of the retardation film of the invention while dried, or, after dried, the edges of the retardation film may be released from the holder, and then the film may be stuck. Preferably, after stuck, the resulting laminate is trimmed at its edges; and in the former, the film is trimmed preferably after stuck to the polarizing film, but in the latter, the film is trimmed preferably before stuck thereto. The trimming method may be any ordinary one. Concretely, the film may be trimmed at both edges with a cutter such as a knife, or may be trimmed according to a method of using laser.

After stuck, the laminate is preferably heated for drying the adhesive and for bettering the polarizing capability thereof. The heating condition may differ depending on the adhesive used. When a water-base adhesive is used, the heating temperature is preferably not lower than 30° C., more preferably from 40 to 100° C., even more preferably from 50 to 90° C. The process is preferably attained in one continuous line in view of the property of the product and the production efficiency thereof.

The back face of the polymer film of the retardation film may be processed for surface treatment to improve the adhesiveness thereof.

The surface treatment may be, for example, glow discharge treatment, UV irradiation treatment, corona treatment, flame treatment, or acid or alkali treatment.

The glow discharge treatment as referred to herein may be low-temperature plasma treatment with a low-pressure gas at from 10⁻³ to 20 Torr, or may also be plasma treatment under atmospheric pressure.

The plasma-exciting vapor is a vapor that may be excited with plasma under the condition as above, including argon, helium, neon, krypton, xenon, nitrogen, carbon dioxide, flons such as tetrafluoromethane, and their mixtures.

These are described in detail in Hatsumei Kyokai Disclosure Bulletin No. 2001-1745 (issued on Mar. 15, 2001, by Hatsumei Kyokai), pp. 30-32.

For plasma treatment under atmospheric pressure recently specifically noted in the art, for example, employed is irradiation energy of from 20 to 500 kGy under from 10 to 1,000 keV, more preferably irradiation energy of from 20 to 300 kGy under from 30 to 500 keV.

The polarizing film is, for example, one prepared by dyeing a polarizing film of polyvinyl alcohol or the like with iodine, and stretching it. After stretched, the film may be dried for lowering the volatile content therein. The drying may be attained after the retardation film or any other protective film is stuck thereto, in a separate heating step.

In case where any other polymer film exists as a polarizing film-protective film, between the polarizing film and the retardation film of the invention, it is desirable that the film is substantially isotropic. Concretely, in-plane retardation Re of the film is preferably from 0 to 10 nm, more preferably from 0 to 7 nm, even more preferably from 0 to 5 nm. Its thickness-direction retardation Rth is preferably from −25 to 25 nm, more preferably from −15 to 15 nm, even more preferably from −10 to 10 nm.

In case where the retardation film of the invention is stuck to an isotropic film, an isotropic adhesive is preferably used. The isotropic film is preferably a cellulose acylate film.

Preferably, the polarizing plate of the invention has the retardation film of the invention (retardation film of the first or second aspect) on one surface of a polarizing film and has a protective film on the other surface thereof. The protective film is preferably a cellulose acylate film.

One embodiment of the polarizing plate of the invention comprises a polarizing film, the retardation film of the invention (serving also as a protective film for the polarizing film) and a second retardation film (negative A-plate or biaxial film) to be mentioned hereinunder, in that order.

The optical properties and the durability (short-term, long-term storability) of the polarizing plate of the invention are preferably on the same level as that of commercial super-high contrast products (for example, Sanritz's HLC2-5618).

Concretely, the polarizing plate is preferably as follows: Its visible light transmittance is at least 42.5%. Its degree of polarization {(Tp−Tc)/(Tp+Tc)}^{1/2}≧0.9995 (in which Tp indicates a parallel transmittance, Tc indicates a cross transmittance). When it is left in an atmosphere at 60° C. and 90% RH for 500 hours, and in a dry atmosphere at 80° C. for 500 hours, the light transmittance change before and after the test is at most 3% based on the absolute value thereof, more preferably at most 1%, and the degree of polarization change is at most 1% based on the absolute value thereof, more preferably at most 0.1%.

Preferably, the polarizing plate of the invention has at least one layer of a hard coat layer, an antiglare layer or an antireflection layer, on the surface (viewing side) of the protective film on at least one side of the polarizer.

In use of the polarizing plate in a liquid-crystal display device, the protective film to be disposed on the side opposite to the liquid-crystal cell preferably has, as provided thereon, a functional film such as an antireflection layer; and as the functional layer, preferred is at least one layer of a hard coat layer, an antiglare layer or an antireflection layer.

It is not always necessary to provide these layers as separate layers. For example, the antireflection layer or the hard coat layer may be made to have an antiglare function, and the resulting layer may be provided as an antiglare antireflection layer in place of individually providing the two layers of antireflection layer and antiglare layer.

### Antireflection Layer:

In the invention, an antireflection layer comprising at least a light-scattering layer and a low-refractivity layer as laminated in that order, or an antireflection layer comprising a middle-refractivity layer, a high-refractivity layer and a low-refractivity layer as laminated in that order is preferably formed on the protective film of the polarizer. Preferred examples of those cases are mentioned below. In the former constitution, in general, the mirror reflectivity of the layer may be generally at least 1%, and the layer is referred to as a low-reflection (LR) film. In the latter constitution, the layer may realize a mirror reflectivity of at most 0.5%, and this is referred to as anti-reflection (AR) film.

### LR Film:

Described are preferred examples of the constitution where an antireflection layer (LR film) comprising a light-scattering layer and a low-refractivity layer is formed on the protective film of a polarizer.

Preferably, mat particles are dispersed in the light-scattering layer; and refractive index of the material of the other part than the mat particles in the light-scattering layer is preferably within a range of from 1.50 to 2.00. The refractive index of the low-refractivity layer is preferably within a range of from 1.20 to 1.49.

In the invention, the light-scattering layer also has antiglare and hard coat properties, and it may be a single layer, or may be formed of plural layers, for example, from 2 to 4 layers.

Regarding the surface roughness profile thereof, the antireflection layer is preferably so planned that the center line mean roughness Ra is from 0.08 to 0.40 μm, the 10-point mean roughness Rz is at most 10 times as large as Ra, the mean projection-recess distance Sm is from 1 to 100 μm, the standard deviation of the projection height from the deepest recess is at most 0.5 μm, the standard deviation of the center line-based mean projection-recess distance Sm is at most 20 μm, the face with a tilt angle of from 0 to 5° accounts for at least 10%. The layer that satisfies the requirements may favorably attain sufficient antiglaring capability and may give uniform mat looks.

Also preferably, the color of the reflected light under a C light source is from −2 to 2 as a* and from −3 to 3 as b*; and the ratio of the minimum to the maximum of the reflectivity within a range of from 380 to 780 nm is from 0.5 to 0.99. Satisfying the requirements, the reflected light on the film may be neutral.

Further, the color of the transmitted light under a C light source is preferably from 0 to 3 as b*. When the film is applied to a display device, the white display is prevented from yellowing.

Also preferably, the standard deviation of the brightness distribution measured on the film with inserting a lattice of 120 μm×40 μm between the surface illuminant and the antireflection layer is at most 20. When the polarizing plate of the invention that satisfies the requirement is applied to a high-definition panel, the surface glaring may be reduced.

The optical properties of the antireflection layer for use in the invention are preferably as follows: The mirror reflectivity is at most 2.5%, the transmittance is at least 90%, the 60° gloss is at most 70%. Having the preferred optical properties, the layer may prevent external light reflection thereon and its visibility may be thereby bettered. In particular, the mirror reflectivity is more preferably at most 1%, even more preferably at most 0.5%.

Also preferably, the haze is from 20 to 50%; the ratio of inner haze/total haze is from 0.3 to 1; the haze reduction from the haze after the formation of the light-scattering layer to that after the formation of the low-refractivity layer is at most 15%; the transmitted image sharpness through a comb width of 0.5 mm is from 20 to 50%; the transmittance ratio of vertical transmittance/transmittance at 2° inclined from vertical is from 1.5 to 5.0. The polarizing plate satisfying the requirements may be effective for glaring prevention and for image or letter blurring on high-precision LCD panels.

### Low-Refractivity Layer:

The refractive index of the low-refractivity layer for use in the invention is preferably from 1.20 to 1.49, more preferably from 1.30 to 1.44. Also preferably, the low-refractivity layer satisfies the following numerical expression (C) for refractivity reduction.

(m/4)λ×0.7<n_{L}d_{L}<(m/4)λ×1.3 (C)

In the numerical expression (C), m indicates a positive odd number; n_{L} indicates the refractive index of the low-refractivity layer; d_{L} indicates the film thickness (nm) of the low-refractivity layer; λ indicates a wavelength falling within a range of from 500 to 550 nm.

### 5. Second Retardation Film:

5.-l Examples of Second Retardation Film to be Used with Retardation Film of First Aspect of the Invention:

The retardation film of the first aspect of the invention is preferably used for optical compensation in liquid-crystal display devices, as combined with a second retardation film. More preferably, it is combined with a negative A-plate as the second retardation film, for optical compensation in VA-mode liquid-crystal display devices.

The negative A-plate to be combined with the retardation film of the first aspect of the invention preferably satisfies the following formulae (3-1) and (4-1):

70 nm≦Re(550)≦210 nm (3-1)

−0.6≦Rth(550)/Re(550)≦−0.4; (4-1)

more preferably the following formulae (3-1)′ and (4-1)′:

100 nm≦Re(550)≦180 nm (3-1)′

−0.57≦Rth(550)/Re(550)≦−0.43; (4-1)+

even more preferably the following formulae (3-1)″ and (4-1)″:

120 nm≦Re(550)≦160 nm (3-1)″

−0.55≦Rth(550)/Re(550)≦−0.45. (4-1)″

### 5.-1-1 Negative A-Plate (Example of Second Retardation Film):

The negative A-plate to be combined with the retardation film of the first aspect of the invention is described in detail hereinunder.

The negative A-plate is a retardation plate having an in-plane slow axis and having a property of Rth/Re at a wavelength of 550 nm of about −0.5. In the invention, the “negative A-plate” is not always required to have Rth/Re of −0.5, and may include any ones satisfying the above formulae (3-1) and (4-1).

The negative A-plate may be a polymer film and, for example, may be any of cellulose acylate film, norbornene film, polycarbonate film, polyester and polysulfone film.

The negative A-film may be produced, for example, by stretching a single-layered or multi-layered film that contains a material having a negative intrinsic birefringence value.

For the negative A-plate, usable is a polymer film produced according to any film formation method of a melt-casting film formation method substantially with no solvent or a solution-casting method with a solvent. In case where the film is a multi-layered film, it may be produced according to a melt coextrusion method or a co-casting method. After its formation, the film may be continuously stretched and shrunk in the manner as above. For example, in case where a film produced according to a solution-casting method is employed, it may be stretched and shrunk during the drying step of the solution-casting method, or may be stretched and shrunk in place of wet stretching. The film formed according to a melt extrusion method or the film formed and dried according to a solution-casting method may be continuously stretched and shrunk. Needless-to-say, the film may be once rolled up and then separately stretched and shrunk.

One example of the negative A-plate is a single-layered or multi-layered film that contains a material having a negative intrinsic birefringence value.

The intrinsic birefringence value Δn⁰ of the material is computed according to the following formula [1]:

Δn⁰=(2π/9)(Nd/M) {(nₐ+2)²/nₐ} (α₁−α₂) [1]

In this, π indicates the ratio of the circumference of a circle to its diameter; N indicates an Avogadro constant; d indicates a density; M indicates a molecular weight; nₐ indicates a mean refractive index; α₁ indicates the degree of polarizability in the molecular chain axis direction of a polymer; α₂ indicates the degree of polarizability in the direction vertical to the molecular chain axis of the polymer.

As the material having a negative intrinsic birefringence value, preferred is a polymer material; and the film is preferably a single-layered or multi-layered film containing, as the main ingredient (this means at least 50% by mass as the solid content), a polymer material having a negative intrinsic birefringence value.

One example of the polymer having a negative intrinsic birefringence value is an vinyl aromatic polymer. The vinyl aromatic polymer includes, for example, polystyrene, and copolymers of a vinyl aromatic monomer such as styrene, α-methylstyrene, o-methylstyrene, p-methylstyrene, p-chlorostyrene, p-nitrostyrene, p-aminostyrene, p-carboxystyrene or p-phenylstyrene, with other monomer such as ethylene, propylene, butadiene, isoprene, (meth)acrylonitrile, α-chloroacrylonitrile, methyl (meth)acrylate, ethyl (meth)acrylate, (meth)acrylic acid, maleic anhydride or vinyl acetate. Of those, preferred are polystyrene and copolymer of styrene and maleic anhydride. Not detracting from the negative intrinsic birefringence thereof, the polymer may be further copolymerized with any other monomer whereby its physical properties such as glass transition temperature or photoelasticity may be controlled and any other function may be imparted thereto.

Other examples of the polymer having a negative intrinsic birefringence value include fluorene skeleton-having polycarbonates. The fluorene skeleton is aligned vertically to the polymer main chain by stretching or the like operation, therefore exhibiting a large negative polarizability.

Examples of the fluorene skeleton-having polycarbonate are polymers having a repetitive unit of the following formula (I):

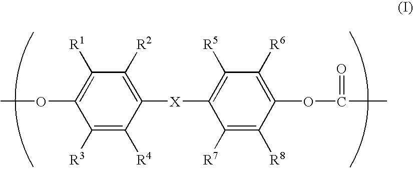

In this, R¹ to R⁸ each independently represent a group selected from a hydrogen atom, a halogen atom, a hydrocarbon group having from 1 to 6 carbon atoms and a hydrocarbon-O— group having from 1 to 6 carbon atoms; and X represents a group of the following formula (1)-1:

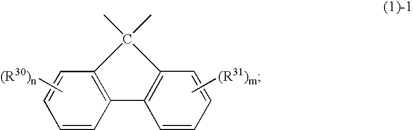

R³⁰ and R³¹ each independently represent a halogen atom or an alkyl group having from 1 to 3 carbon atoms; n and m each independently indicate an integer of from 0 to 4.

Preferably, the polymer contains the repetitive unit of formula (I) in an amount of from 50 to 95 mol % of all the repetitive units constituting the polymer, more preferably from 60 to 95 mol %, even more preferably from 70 to 90 mol %.

The fluorene skeleton-having polycarbonates have a high glass transition point temperature and have excellent properties in point of the handlability and the blow moldability.

More preferred examples of the polycarbonate are polymers containing the repetitive unit of the above formula (I) and a repetitive unit of the following formula (II):

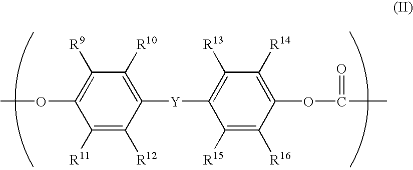

In formula (II), R⁹ to R¹⁶ each independently represent at least one group selected from a hydrogen atom, a halogen atom and a hydrocarbon group having from 1 to 22 carbon atoms; Y represents a group of the following formulae:

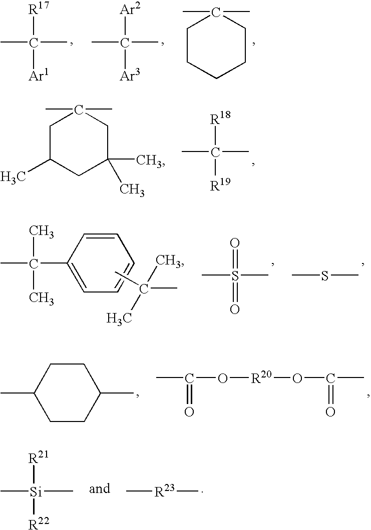

In this, R¹⁷ to R¹⁹, R²¹ and R²² in Y each independently represent a hydrogen atom, a halogen atom, or a hydrocarbon group having from 1 to 22 carbon atoms such as an alkyl group or an aryl group; R²⁰ and R²³ each represent a hydrocarbon group having from 1 to 20 carbon atoms such as an alkyl group or an aryl group; and Ar¹ to Ar³ each independently represent an aryl group having from 6 to 10 carbon atoms such as a phenyl group.

5.-2 Examples of Second Retardation Film for Use with Retardation Film of Second Aspect of the Invention:

The retardation film of the second aspect of the invention is preferably used for optical compensation in VA-mode liquid-crystal display devices, as combined with a biaxial film having an Nz value of 0.5 or so.

The biaxial film having an Nz value of about 0.5 that is favorably combined with the retardation film of the second aspect of the invention is described.

The biaxial film is preferably a retardation film having a relation of nx>nz>ny and satisfying the following formulae (3-2) and (4-2):

200 nm≦Re(550)≦300 nm (3-2)

0.3<Nz<0.7, (4-2)

more preferably a biaxial film satisfying the following formulae (5-2) and (6-2):

240 nm≦Re(550)≦290 nm (5-2)

0.4≦Nz≦0.6. (6-2)

More precisely, in-plane retardation of the biaxial film is preferably at least 240 nm for enhancing its compensation capability, more preferably at least 260 nm. Also preferably, it is at most 290 nm, more preferably at most 280 nm.

The Nz value is preferably equal to or more than 0.4 for enhancing the compensation capability of the film, and more preferably equal to or more than 0.45. Also preferably, it is equal to or less than 0.6, and more preferably equal to or less than 0.55.

The biaxial film having the optical properties as above includes, for example, birefringent films of high-molecular polymers and aligned films of liquid-crystal polymers.

The high-molecular polymers include, for example, polystyrene, polycarbonate, polyolefin such as polypropylene, polyester such as polyethylene terephthalate or polyethylene naphthalate, alicyclic polyolefin such as polynorbornene, polyvinyl alcohol, polyvinyl butyral, polymethyl vinyl ether, polyhydroxyethyl acrylate, hydroxyethyl cellulose, hydroxypropyl cellulose, methyl cellulose, polyarylate, polysulfone, polyether sulfone, polyphenylene sulfide, polyphenylene oxide, polyaryl sulfone, polyvinyl alcohol, polyamide, polyimide, polyvinyl chloride, cellulose polymer, and various types of their binary or ternary copolymers, graft copolymers and blends. The retardation film may be produced according to a method of biaxially stretching the high-molecular polymer film in the plane direction; or according to a method of monoaxially or biaxially stretching it in the plane direction and further stretching it in the thickness direction thereby controlling the refractive index in the thickness direction. It may also be produced according to a method of adhering a thermoshrinking film to a high-molecular polymer film and heating it to thereby stretch and/or shrink the polymer film under the action of the shrinking force of the thermoshrinking film for oblique alignment of the polymer film.

The liquid-crystal polymer includes, for example, various main-chain-type or branch-type polymers with a liquid crystal alignment-imparting, conjugated linear atomic group (mesogen) introduced into the main chain or the branch of the polymer. Specific examples of the main-chain-type liquid-crystal polymer include, for example, nematic alignment polyester-type liquid-crystal polymers, discotic polymers and cholesteric polymers, having a mesogen group bonding thereto at the flexibility-imparting spacer segment. Specific examples of the branch-type liquid-crystal polymer include, for example, those having a main chain skeleton of polysiloxane, polyacrylate, polymethacrylate or polymalonate and having, as the side branch, a mesogen segment of a nematic alignment-imparting, para-substituted cyclic compound unit via the spacer segment of a conjugated atomic group therebetween. The alignment film of such a liquid-crystal polymer is preferably one prepared by rubbing the surface of a thin film of polyimide or polyvinyl alcohol formed on a glass plate; or one prepared by casting a liquid-crystal polymer solution onto an alignment-treated surface of a silicon oxide film formed by oblique vapor deposition, and then heat-treating it to thereby align the liquid-crystal polymer especially for oblique alignment.

Above all, the biaxial film is especially preferably any of a cellulose acylate film, a norbornene film, a polycarbonate film, a polyester film and a polysulfone film.

For lamination of the biaxial film and the polarizer and further with a liquid-crystal panel, they may be merely disposed in order and may be laminated with an adhesive layer or the like. The adhesive to form the adhesive layer is not specifically defined. For example, it may be suitably selected from those comprising, as the base polymer, a polymer of acrylic polymer, silicone polymer, polyester, polyurethane, polyamide, polyether, fluoropolymer or rubber polymer. In particular, especially preferred are those having excellent optical transparency and good adhesive properties such as suitable wettability, coagulability and adhesiveness and having excellent weather resistance and heat resistance, such as acrylic adhesives.

The biaxial film and other layers such as adhesive layer may be suitably processed so as to make them have UV absorbability, for example, with an UV absorbent such as salicylate compound, benzophenol compound, benzotriazole compound, cyanoacrylate compound or nickel complex compound.

### 6. Liquid-Crystal Display Device:

The invention also relates to a liquid-crystal display device comprising the retardation film of the invention (retardation film of the first or second aspect) and/or the polarizing plate of the invention.

The liquid-crystal display device of the invention may be any of reflection-type, semitransmission-type or transmission-type liquid-crystal display devices. The liquid-crystal display device generally comprises a polarizing plate, a liquid-crystal cell, and optionally other members of a retardation film, a reflection layer, a light-diffusing layer, a backlight, a front light, an optical control film, a light guide, a prism sheet, a color filter, etc. No specific limitation should be given to the liquid-crystal display device of the invention except that the device comprises the polarizing plate of the invention as the indispensable element. In this, the liquid-crystal cell is not specifically defined, and may be any ordinary liquid-crystal cell, for example, having a liquid-crystal layer sandwiched between a pair of electrode-having transparent substrates. Not specifically defined, the transparent substrate that constitutes the liquid-crystal cell may be any one capable of aligning the liquid-crystal material to constitute the liquid-crystal layer, in a specific alignment direction. Concretely, it may be any of a transparent substrate having the property of aligning liquid crystal by itself; or a transparent substrate not having an aligning capability by itself but coated with an alignment film or the like having the property of aligning liquid crystal. The electrode for the liquid-crystal cell may be any ordinary one. In general, the electrode may be provided on the surface of the transparent substrate to be kept in contact with the liquid-crystal layer. In case where a substrate having an alignment film is used, then the electrode may be provided between the substrate and the alignment film. Not specifically defined, the liquid-crystal material to form the liquid-crystal layer includes various types of ordinary low-molecular liquid-crystal compounds, high-molecular liquid-crystal compounds and their mixtures capable of forming various liquid-crystal cells. Not detracting from the liquid crystallinity, a dye, a chiral agent, a non-liquid-crystal compound or the like may be added to the layer.

The liquid-crystal cell may additionally comprise any other various necessary constitutive elements to constitute various types of liquid-crystal cells mentioned below, than the above-mentioned electrode substrate and liquid-crystal layer. The liquid-crystal cell mode includes various different types of modes such as a TN (twisted nematic) mode, an STN (super-twisted nematic) mode, an ECB (electrically controlled birefringence) mode, an IPS (in-plane switching) mode, a VA (vertical alignment) mode, an MVA (multidomain vertical alignment) mode, a PVA (patterned vertical alignment) mode, an OCB (optically compensated birefringence) mode, a HAN (hybrid aligned nematic) mode, an ASM (axially symmetric aligned microcell) mode, a halftone grain scale mode, a multidomain mode, and a display mode of using a ferroelectric liquid crystal and an antiferroelectric liquid crystal. The driving system for the liquid-crystal cell is not also specifically defined. The driving system may be any of a passive matrix system for STN-LCD or the like, as well as an active matrix system of using an active electrode such as TFT (thin film transistor) electrode, TFD (thin film diode) electrode or the like, or a plasma address system. Also employable herein is a field sequential system not using a color filter.

Not specifically defined, the liquid-crystal cell mode is preferably a VA mode.

### 6.-1 Examples of Liquid-Crystal Display Device Having the Retardation Film of First Aspect:

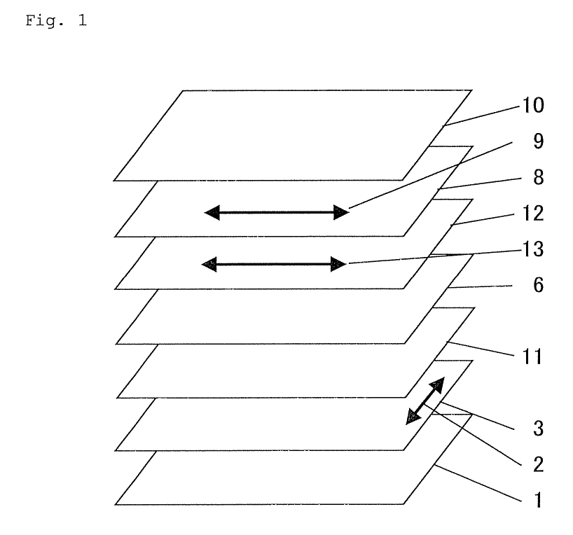

Preferred examples of the liquid-crystal display device having the retardation film of the first aspect of the invention are described with reference to the drawings. In FIG. 1 to FIG. 3, the same reference numeral is given to the same members.

FIG. 1 is a schematic view showing the constitution of an embodiment of a VA-mode liquid-crystal display device having a retardation film of the first aspect of the invention, in which the device has a negative A-plate mounted thereon along with the retardation film of the first aspect of the invention.

The liquid-crystal display device of FIG. 1 comprises a pair of first polarizing film 3 and second polarizing film 8 disposed with their absorption axes 9 and 2 kept perpendicular to each other, and a liquid-crystal cell 6 disposed between the pair of polarizing films 3 and 8. The liquid-crystal cell 6 comprises a pair of substrates, and a liquid-crystal layer disposed between the pair of substrates, though not shown in the drawing; and the liquid-crystal molecules in the liquid-crystal layer are aligned substantially vertically to the substrate at the time of black level of display, or that is, the liquid-crystal cell is a vertical alignment mode cell. A protective film is disposed on the outer surface of each of the first and second polarizing films 3 and 8.

The liquid-crystal display device of FIG. 1 additionally has a first retardation film (retardation film of the first aspect of the invention) 11 disposed between the first polarizing film 3 and the liquid-crystal cell 6, and a second retardation film 11 disposed between the second polarizing film 8 and the liquid-crystal cell 6. The first and second retardation films 11 and 12 each function as a protective film for the first and second polarizing films 3 and 8 on the side of the liquid-crystal cell.

In FIG. 1, the in-plane slow axis of the second retardation film 12 is in parallel to the absorption axis of the second polarizing film 8, and the film 12 has optical properties that satisfy the above-mentioned formulae (3-1) and (4-1). In FIG. 1, any of the first and second polarizing films 3 and 8 may be the polarizing film on the backlight side or the polarizing film on the viewing side; but the first polarizing film 3 is preferably on the backlight side.

In FIG. 1, the laminate comprising the first retardation film 11, the first polarizing film 3 and the protective film 1 is the polarizing plate of the invention, and this is preferably a backlight-side polarizing plate.

The VA-mode liquid-crystal cell 6 may be any of (1) a VA-mode liquid-crystal cell of a narrow sense of the word, in which rod-like liquid-crystal molecules therein are aligned substantially vertically in no voltage application thereto but are aligned substantially horizontally in voltage application thereto (as described in JP-A 2-176625), or (2) an MVA mode liquid-crystal cell in which the VA-mode is multidomained for viewing angle enlargement (as described in SID97, Digest of Tech. Papers (preprinted) 28 (1997) 845), or (3) an n-ASM mode liquid-crystal cell in which the rod-like liquid-crystal molecules therein are aligned substantially vertically in no voltage application thereto but are aligned for twisted multidomain alignment in voltage application thereto (as described in Preprints 58 to 59 in the Japan Liquid Crystal Symposium (1998)), or (4) a survival mode liquid-crystal cell (as announced in LCD International 98).

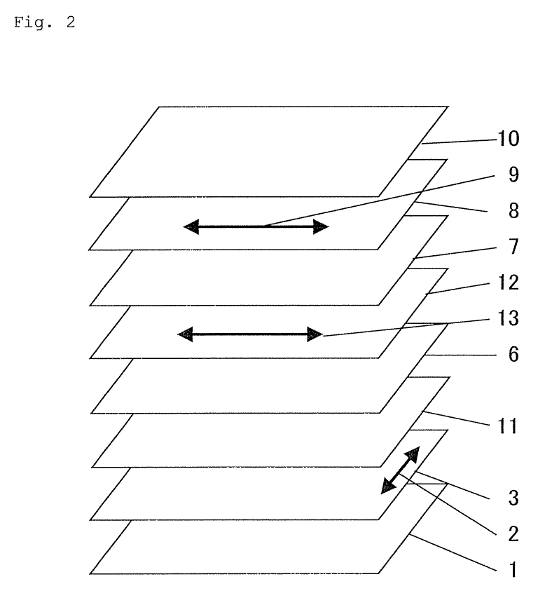

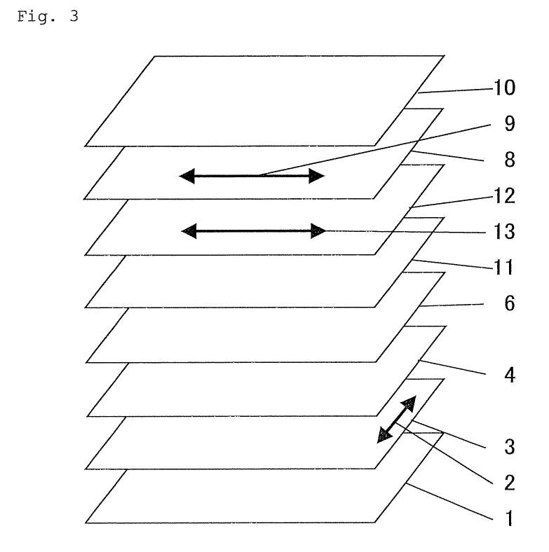

FIG. 2 is a schematic view showing the constitution of another embodiment of a VA-mode liquid-crystal display device having a negative A plate as mounted thereon along with the retardation film of the first aspect of the invention.

Differing from the constitution shown in FIG. 1, a protective film 7 for the second polarizing plate is inserted between the second retardation film 12 and the polarizing film 8 in the constitution of FIG. 2.

In this embodiment, the protective film 7 for the second polarizing plate is preferably a substantially optically isotropic film. Preferably, the substantially isotropic film has an in-plane retardation (Re) of from 0 to 20 nm, more preferably from 0 to 10 nm, most preferably from 0 to 5 nm. Its thickness-direction retardation (Rth) is preferably from −60 nm to 60 nm, more preferably from −40 nm to 40 nm, even more preferably from −20 nm to 20 nm. The wavelength dispersion characteristics of retardation of the film, Re400/Re700 is preferably less than 1.2.

Satisfying the above-mentioned optical properties, the material of the protective film 7 for the polarizing plate is not specifically defined, but is preferably a cellulose ester film from the viewpoint of the easiness in working it into polarizing plate.

In this embodiment, the preferred range of the optical properties of the first retardation film 11 and the second retardation film 12 is the same as in the liquid-crystal display device having the constitution shown in FIG. 1.

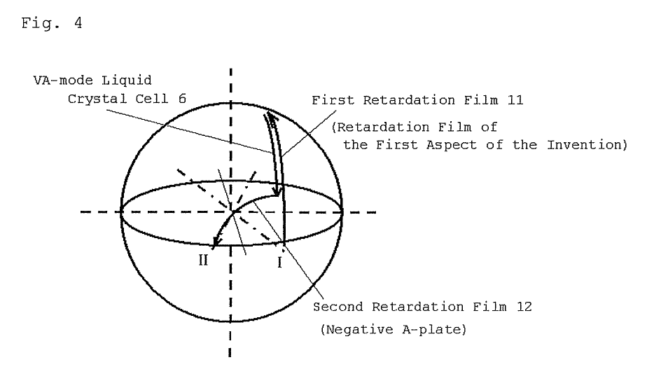

FIG. 3 is a schematic view showing the constitution of another embodiment of A VA-mode liquid-crystal display device.

The liquid-crystal display device of FIG. 3 comprises first and second retardation films 11 and 12, laminated and disposed between the second polarizing film 8 and the liquid-crystal cell 6.

In FIG. 3, the first retardation film 11 is the retardation film of the first aspect of the invention.

In FIG. 3, the in-plane slow axis 13 of the second retardation film 12 is in parallel to the absorption axis 9 of the second polarizing film 8, and has optical properties satisfying the above formulae (3-1) and (4-1).

In FIG. 3, any of the first and second polarizing films 3 and 8 may be a polarizing film on the backlight side or a polarizing film on the viewing side; but preferably, the first polarizing film 3 is on the backlight side.

As the embodiment of the VA-mode liquid-crystal display device with the retardation film of the first aspect of the invention and a negative A-plate mounted thereon, preferred is any constitution of FIG. 1 to FIG. 3, but more preferred is the constitution of FIG. 1.

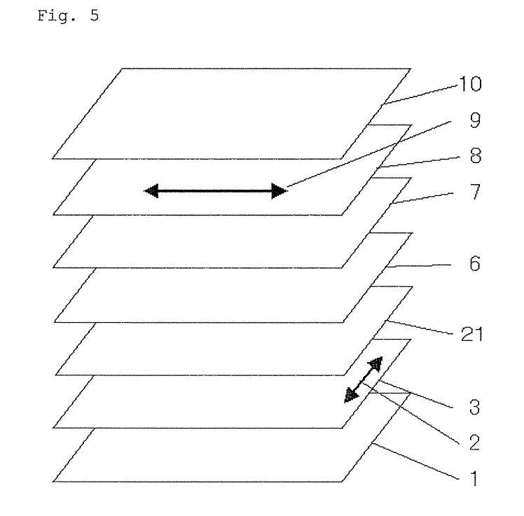

FIG. 4 shows one example of the optical compensation mechanism of the VA-mode liquid-crystal display device of FIG. 1, as traced on a Poincare sphere. FIG. 4 shows the trace of light on a Poincare sphere, in which the polarization state I of the light running through the first polarizing film 3 in FIG. 1 passes through the first retardation film (retardation film of the first aspect of the invention) 11, the liquid-crystal cell 6 and the second retardation film 12, and reaches the extinction point II in the oblique direction (45°). Since the retardation film of the first aspect of the invention is used as the first retardation film 11, the wavelength dependence of the birefringence of the liquid-crystal cell 6 is cancelled as the light entering the device passes through the first retardation film 11, and thereafter the polarization state of every light of R, G and B can be near the extinction point II by the action of the second retardation film 12. As a result, the device is free from light leakage in oblique directions and may have little color shift.

### 6.-2 Examples of Liquid-Crystal Display Device Having the Retardation Film of Second Aspect:

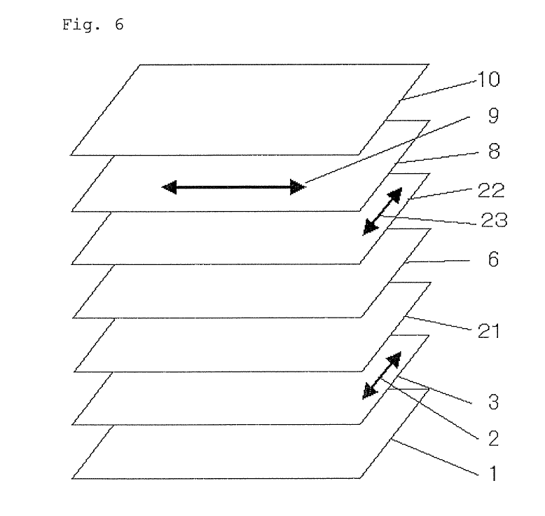

Preferred examples of the liquid-crystal display device having the retardation film of the second aspect of the invention are described with reference to the drawings. In FIG. 5 to FIG. 9, the same reference numeral is given to the same members.

FIG. 5 is a schematic view showing the constitution of an embodiment of a VA-mode liquid-crystal display device.

The liquid-crystal display device of FIG. 5 comprises a pair of first polarizing film 3 and second polarizing film 8 disposed with their absorption axes 9 and 2 kept perpendicular to each other, and a liquid-crystal cell 6 disposed between the pair of polarizing films 3 and 8. The liquid-crystal cell 6 comprises a pair of substrates, and a liquid-crystal layer disposed between the pair of substrates, though not shown in the drawing; and the liquid-crystal molecules in the liquid-crystal layer are aligned substantially vertically to the substrate at the time of black level of display, or that is, the liquid-crystal cell is a vertical alignment mode cell. A protective film is disposed on the outer surface of each of the first and second polarizing films 3 and 8.

The liquid-crystal display device of FIG. 5 additionally has a first retardation film (retardation film of the second aspect of the invention) 21 disposed between the first polarizing film 3 and the liquid-crystal cell 6. The first retardation film 21 functions also as a protective film for the first polarizing film 3 on the side of the liquid-crystal cell.

In the constitution of FIG. 5, thickness-direction retardation (Rth) of the first retardation film, or that is, the retardation film of the second aspect of the invention is from 200 to 400 nm, preferably from 230 to 370 nm, more preferably from 250 to 400 nm, even more preferably from 270 to 330 nm.

Rth(450)/Rth(550) is from 1.04 to 1.09, more preferably from 1.05 to 1.09, even more preferably from 1.06 to 1.08.

In this constitution, it is desirable that the wavelength dispersion characteristics of retardation, Rth(450)/Rth(550) of the first retardation film is substantially the same as Rth(450)/Rth(550) of the liquid-crystal cell; and concretely, the absolute value of the difference between the two is preferably at most 0.03, more preferably at most 0.02, even more preferably at most 0.01.

In FIG. 5, any of the first and second polarizing films 3 and 8 may be the polarizing film on the backlight side or the polarizing film on the viewing side; but the first polarizing film 3 is preferably on the backlight side.

The VA-mode liquid-crystal cell 6 may be any of (1) a VA-mode liquid-crystal cell of a narrow sense of the word, in which rod-like liquid-crystal molecules therein are aligned substantially vertically in no voltage application thereto but are aligned substantially horizontally in voltage application thereto (as described in JP-A 2-176625), or (2) an MVA mode liquid-crystal cell in which the VA-mode is multidomained for viewing angle enlargement (as described in SID97, Digest of Tech. Papers (preprinted) 28 (1997) 845), or (3) an n-ASM mode liquid-crystal cell in which the rod-like liquid-crystal molecules therein are aligned substantially vertically in no voltage application thereto but are aligned for twisted multidomain alignment in voltage application thereto (as described in Preprints 58 to 59 in the Japan Liquid Crystal Symposium (1998)), or (4) a survival mode liquid-crystal cell (as announced in LCD International 98).

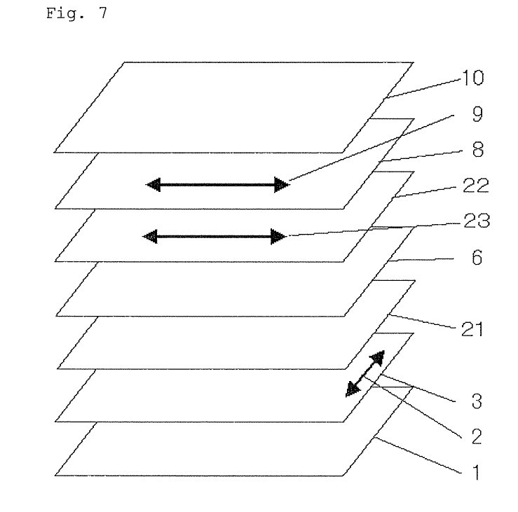

FIG. 6 and FIG. 7 each are a schematic view showing the constitution of an embodiment of a VA-mode liquid-crystal display device of the invention, having a second retardation film of a biaxial film along with the retardation film of the first aspect of the invention.

The constitution of FIG. 6 differs from that of FIG. 7 only in point of the axial disposition of the second retardation film (direction of the slow axis).

The liquid-crystal display device of FIG. 6 comprises a pair of first polarizing film 3 and second polarizing film 8 disposed with their absorption axes 9 and 2 kept vertical to each other, and a liquid-crystal cell 6 disposed between the pair of polarizing films 3 and 8. The liquid-crystal cell 6 comprises a pair of substrates, and a liquid-crystal layer disposed between the pair of substrates, though not shown in the drawing; and the liquid-crystal molecules in the liquid-crystal layer are aligned substantially vertically to the substrate at the time of black level of display, or that is, the liquid-crystal cell is a vertical alignment mode cell. A protective film is disposed on the outer surface of each of the first and second polarizing films 3 and 8.

The liquid-crystal display device of FIG. 6 additionally has a first retardation film (retardation film of the second aspect of the invention) 21 disposed between the first polarizing film 3 and the liquid-crystal cell 6, and a second retardation film 22 of a biaxial film disposed between the second polarizing film 8 and the liquid-crystal cell 6. The first and second retardation films 21 and 22 function also as a protective film for the first and second polarizing films 3 and 8 on the side of the liquid-crystal cell.

In the constitution of FIG. 6 or FIG. 7, thickness-direction retardation (Rth) of the first retardation film, or that is, the retardation film of the second aspect of the invention is from 200 to 400 nm, preferably from 230 to 370 nm, more preferably from 250 to 400 nm, even more preferably from 270 to 330 nm.

Rth(450)/Rth(550) is from 1.04 to 1.09, more preferably from 1.05 to 1.09, even more preferably from 1.06 to 1.09, still more preferably from 1.06 to 1.08.

In FIG. 6, the in-plane slow axis of the second retardation film 22 is perpendicular to the absorption axis of the second polarizing film 8, and has optical properties satisfying the above formulae (3-2) and (4-2). The second retardation film 22 is a biaxial film, and its in-plane retardation Re(550) is from 200 to 300 nm, preferably from 240 to 290 nm, more preferably from 260 to 280 nm. Its Nz value is about 0.5, concretely 0.3<Nz<0.7, preferably from 0.4 to 0.6.

In FIG. 6, any of the first and second polarizing films 3 and 8 may be the polarizing film on the backlight side or the polarizing film on the viewing side; but the first polarizing film 3 is preferably on the backlight side.

In FIG. 6, the laminate comprising the first retardation film 21, the first polarizing film 3 and the protective film 1 is the polarizing plate of the invention, and this is preferably a backlight-side polarizing plate.

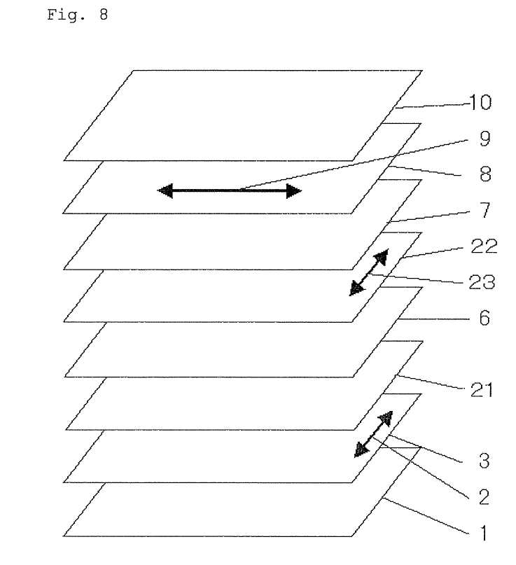

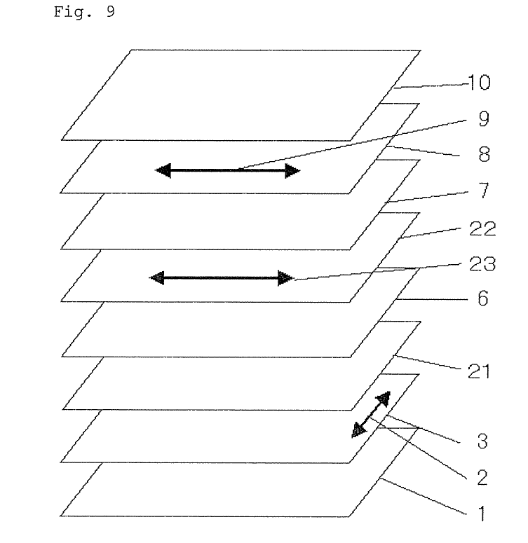

FIG. 8 and FIG. 9 each are a schematic view showing the constitution of other embodiments of a VA-mode liquid-crystal display device of the invention, having a second retardation film of a biaxial film along with the retardation film of the second aspect of the invention. The constitution of FIG. 8 differs from that of FIG. 6 in that a second polarizer protective film (on the cell side) is inserted between the second retardation film and the second polarizing film in the former. Similarly, the constitution of FIG. 9 differs from that of FIG. 7 in that a second polarizer protective film (on the cell side) is inserted between the second retardation film and the second polarizing film in the former. The constitutions of FIG. 8 and FIG. 9 differ in point of the axial disposition of the second retardation film (slow axis direction).

In the constitutions of FIG. 8 and FIG. 9, the second polarizer protective film is preferably a substantially optically isotropic film.

In-plane retardation (Re) of the substantially isotropic film is preferably from 0 to 20 nm, more preferably from 0 to 10 nm, most preferably from 0 to 5 nm. Its thickness-direction retardation (Rth) is preferably from −60nm to 60 nm, more preferably from −40 nm to 40 nm, even more preferably from −20 nm to 20 nm. The wavelength dispersion characteristics of retardation of the film, Re400/Re700 is preferably less than 1.2.

Satisfying the above-mentioned optical properties, the material of the polarizer protective film is not specifically defined, but is preferably a cellulose ester film from the viewpoint of the easiness in working it into polarizer.

In the constitutions of FIG. 8 and FIG. 9, the preferred range of the optical properties of the first retardation film and the second retardation film is the same as in the liquid-crystal display device having the constitution shown in FIG. 6 or FIG. 7.

Examples of the VA-mode device of the invention that comprises the second retardation film and the retardation film of the second aspect of the invention may have any of the constitutions of FIG. 6 to FIG. 9; however, for more accurate optical compensation, preferred is the constitution of FIG. 6 or FIG. 8, and more preferred is the constitution of FIG. 6 as capable of further reducing the thickness of the liquid-crystal panel.

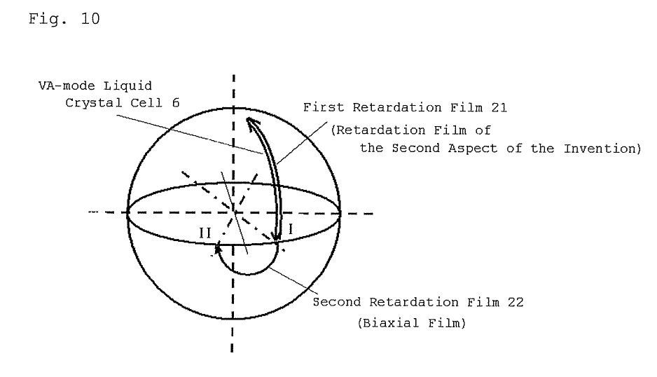

FIG. 10 shows one example of the optical compensation mechanism of the VA-mode liquid-crystal display device having a constitution of FIG. 8, as traced on a Poincare sphere. FIG. 10 shows the trace of light on a Poincare sphere, in which the polarization state I of the light running through the first polarizing film 3 in FIG. 8 passes through the first retardation film (retardation film of the second aspect of the invention) 21, the liquid-crystal cell 6 and the second retardation film 22, and reaches the extinction point II in the oblique direction (45°). Since the retardation film of the second aspect of the invention is used as the first retardation film 21, the wavelength dependence of the birefringence of the liquid-crystal cell 6 is cancelled as the light entering the device passes through the first retardation film 21, and thereafter the polarization state of every light of R, G and B can be near the extinction point II by the action of the second retardation film 22. As a result, the device is free from light leakage in oblique directions and may have little color shift.

### EXAMPLES

Examples of the invention are described below; however, the invention should not be limited at all to the following Examples.

First described are a retardation film of the first aspect of the invention and a polarizing plate comprising it; and then subsequently described are Examples of a VA-mode liquid-crystal display device with a retardation film of the first aspect of the invention and a negative A-plate mounted thereon.

Next described are a retardation film of the second aspect of the invention and a polarizing plate comprising it; and then subsequently described are Examples of a VA-mode liquid-crystal display device with a retardation film of the second aspect of the invention and a biaxial film mounted thereon.

### 1. Examples of First Aspect of the Invention

### Example 1-1

### <Formation of Cellulose Acetate Film>

### (Formation of Cellulose Acetate Film (CAF1))

The following ingredients were put into a mixing tank and stirred under heat and dissolved, thereby preparing a cellulose acetate solution.

| | Inner Layer | Outer Layer |
|---|---|---|
| Formulation of Cellulose Acetate Solution | (mas. pt.) | (mas. pt.) |
| Cellulose acetate having a degree of | 100 | 100 |
| acetylation of 60.9% | | |
| Triphenyl phosphate (plasticizer) | 7.8 | 7.8 |
| Biphenyldiphenyl phosphate (plasticizer) | 3.9 | 3.9 |
| Methylene chloride (first solvent) | 293 | 314 |
| Methanol (second solvent) | 71 | 76 |
| 1-Butanol (third solvent) | 1.5 | 1.6 |
| Silica fine particles (AEROSIL R972, by | 0 | 0.8 |
| Nippon Aerosil) | | |
| Retardation enhancer of formula (A) | 1.7 | 0 |
| mentioned below | | |

### Formula (A)

Retardation Enhancer:

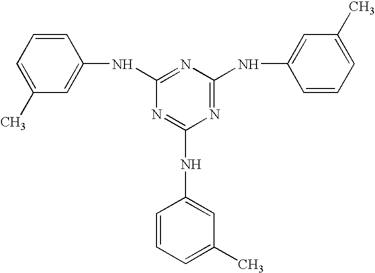

Thus obtained, the dope for inner layer and the dope for outer layer were cast onto a drum cooled at 0° C., using a three-layer co-casting die. The film having a residual solvent content of 70% by mass was peeled away from the drum. With both edges thereof fixed with a pin tenter, this was conveyed at a draw ratio in the machine direction of 110% and dried at 80° C.; and when the residual solvent content thereof reached 10%, this was dried at 110° C. Next, this was dried at 140° C. for 30 minutes, thereby producing a cellulose acetate film (TR1) having a residual solvent content of 0.3% by mass (outer layer: 3 μm, inner layer: 74 μm, outer layer: 3 μ). The optical properties of the produced cellulose acetate film were determined.

The width of the obtained cellulose acetate film was 1340 mm, the thickness thereof was 80 μm. Using KOBRA 21ADH, its retardation (Re) at a wavelength of 550 nm was measured, and was 2 nm. Its retardation (Rth) at a wavelength of 550 nm was measured, and was 90 nm.

(Preparation of Cellulose Acetate Films (CAF2) to (CAF4)) Cellulose acetate films (CAF2) to (CAF4) were produced in the same manner as that for the above cellulose acetate film (CAF1), for which, however, the thickness of the inner layer was changed as in the following Table.

| | CAF1 | CAF2 | CAF3 | CAF4 |
|---|---|---|---|---|
| Thickness of Outer | 3 μm | 3 μm | 3 μm | 3 μm |
| layer | | | | |
| Thickness of Inner | 74 μm | 94 μm | 134 μm | 184 μm |
| layer | | | | |
| Total Thickness | 80 μm | 100 μm | 140 μm | 190 μm |
| Re(550) (nm) | 2 | 2 | 2 | 2 |
| Re(450) (nm) | 83 | 104 | 145 | 197 |
| Rth(550) (nm) | 90 | 113 | 158 | 214 |
| Rth(450)/Rth(550) | 0.92 | 0.92 | 0.92 | 0.92 |

### <Preparation of Retardation Film (F1-1)>

A commercial cellulose acetate film (FUJITAC TD80UF, by FUJIFILM) was led to pass through a dielectric heating roll at 60° C. whereby the film surface temperature was elevated up to 40° C.; and then an alkali solution A having the formulation mentioned below was applied onto it in an amount of 14 ml/m², using a bar coater. Then, this was kept staying under a steam far-IR heater (by Noritake Company) heated at 110C for 10 seconds, and thereafter pure water was applied to it in an amount of 3 ml/m², also using a bar coater. In this stage, the film temperature was 40° C. Next, this was rinsed with water with a fountain coater and dewatered with an air knife, and this operation was repeated three times; and then this was kept staying in a driving zone at 70° C. for 2 seconds, and thus dried.

<Formulation of Alkali Solution A>

| | |
|---|---|
| Potassium hydroxide | 4.7 mas. pts. |
| Water | 15.7 mas. pts. |
| Isopropanol | 64.8 mas. pts. |
| Propylene glycol | 14.9 mas. pts. |
| C₁₆H₃₃O(CH₂CH₂O)₁₀H (surfactant) | 1.0 mas. pt. |

An alignment film coating liquid having the formulation mentioned below was continuously applied onto the saponified surface of the long cellulose acetate film produced in the above, using a wire bar #14. This was dried with hot air at 60° C. for 60 seconds and then with hot air at 100° C. for 120 seconds, thereby forming an alignment film thereon.

Formulation of Alignment Film-Coating Liquid

| | |
|---|---|
| Modified polyvinyl alcohol mentioned below | 10 mas. pts. |
| Water | 371 mas. pts. |
| Methanol | 119 mas. pts. |
| Glutaraldehyde | 0.5 mas. pts. |

### Modified Polyvinyl Alcohol:

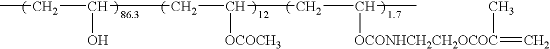

A discotic liquid-crystal compound-containing coating liquid (S1-1) having the formulation mentioned below was prepared, and this was continuously applied onto the alignment film formed in the above, using a wire bar. The film traveling speed (feeding speed) was 20 m/min. During continuously heating it from room temperature up to 80° C., the solvent was dried away, and then this was heated in a drying zone at 120° C. for 90 seconds to thereby align the discotic liquid-crystal compound therein. Next, while the film temperature was kept at 90° C., this was irradiated with UV light at 500 mJ/cm², using a high-pressure mercury lamp, to fix the alignment of the liquid-crystal compound, thereby forming an optically anisotropic layer. The process thus gave a retardation film (F1-1).

### Formulation of Coating Liquid (S1-1):

Formulation of Discotic Liquid-Crystal Compound-Containing
Coating Liquid (S1-1)

| | |
|---|---|
| Discotic liquid-crystal compound (I) | 91 mas. pts. |
| mentioned below | |
| Ethyleneoxide-modified trimethylolpropane triacrylate | 9 mas. pts. |
| (V#360, by Osaka Organic Chemical) | |
| Photopolymerization initiator (Irgacure 907, by | 3 mas. pts. |
| Ciba-Geigy) | |
| Sensitizer (Kayacure DETX, by Nippon Kayaku) | 1 mas. pt. |
| Fluoropolymer A mentioned below | 0.4 mas. pts. |
| Methyl ethyl ketone | 212 mas. pts. |

### Discotic Liquid-Crystal Compound (I):

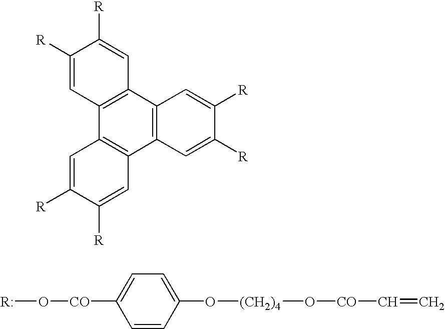

### Fluoropolymer A:

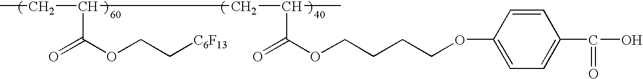

Mw=33000

Using an automatic birefringence meter (KOBRA-21ADH, by Oji Scientific Instruments), the optical properties of the thus-formed retardation film (F1-1) were determined. At a wavelength of 550 nm, Re was 2 nm, and Rth was 370 nm.

### <Preparation of Retardation Films (F2-1) and (F3-1)>

Retardation films (F2-1) and (F3-1) were prepared in the same manner as that for the retardation film (F1-1), for which, however, the commercial cellulose acetate film (FUJITAC TD80UF, by FUJIFILM) used in formation of the retardation film (F1-1) was changed to the cellulose acetate films (CAF3) and (CAF4), respectively, produced in the above, and the thickness of the optically-anisotropic layer was changed in order that the retardation of the films could be as in the following Table.

The optical properties of the thus-formed retardation films (F2-1) and (F3-1) were determined, using an automatic birefringence meter (KOBRA-21ADH, by Oji Scientific Instruments).

### <Preparation of Retardation Film (F4-1)>

In the same manner as that for the formation of the above-mentioned retardation film (F1-1), an alignment film was formed on a commercial cellulose acetate film (FUJITAC TD80UF, by FUJIFILM).

A discotic liquid-crystal compound-containing coating liquid (S2-1) having the formulation mentioned below was prepared, and this was continuously applied onto the alignment film formed in the above, using a wire bar. The film traveling speed was 20 m/min. During continuously heating it from room temperature up to 80° C., the solvent was dried away, and then this was heated in a drying zone at 110° C. for 90 seconds to thereby align the discotic liquid-crystal compound therein. Next, while the film temperature was kept at 70° C., this was irradiated with UV light at 500 mJ/cm², using a high-pressure mercury lamp, to fix the alignment of the liquid-crystal compound, thereby forming an optically anisotropic layer. The process thus gave a retardation film (F4-1)

### Formulation of Coating Liquid (S2-1):

Formulation of Discotic Liquid-Crystal Compound-Containing
Coating Liquid (S2-1)

| | |
|---|---|
| Discotic liquid-crystal compound D-524 | 100 mas. pts. |
| mentioned above | |
| Photopolymerization initiator (Irgacure 907, by | 3 mas. pts. |
| Ciba-Geigy) | |
| Sensitizer (Kayacure DETX, by Nippon Kayaku) | 1 mas. pt. |
| Fluoropolymer A mentioned above | 0.4 mas. pts. |
| Methyl ethyl ketone | 212 mas. pts. |

Using an automatic birefringence meter (KOBRA-21ADH, by Oji Scientific Instruments), the optical properties of the thus-formed retardation film (F4-1) were determined. <Formation of Retardation Films (F5-1) and (F6-1)>

Retardation films (F5-1) and (F6-1) were formed in the same manner as that for the retardation film (F4-1), for which, however, the commercial cellulose acetate film (FUJITAC TD80UF, by FUJIFILM) used in formation of the retardation film (F4-1) was changed to the cellulose acetate films (CAF3) and (CAF4), respectively, produced in the above, and the thickness of the optically-anisotropic layer was changed in order that the retardation of the films could be as in the following Table.

### <Preparation of Retardation Films (F7-1) to (F9-1)>

A coating liquid (S3-1) was prepared in the same manner as that for the coating liquid (S2-1) used in formation of the above retardation film (F4-1), for which, however, discotic compound D-521 was used in the place of D-524.

Retardation films (F7-1) to (F9-1) were prepared in the same manner as that for the above retardation films (F4-1) to (F6-1), for which, however, the coating liquid (S3-1) was used.

### <Preparation of Retardation Films (F10-1) to (F12-1)>

A coating liquid (S4-1) was prepared in the same manner as that for the coating liquid (S2-1) used in preparation of the above retardation film (F3-1), for which, however, discotic compound D-10 was used in the place of D-524.

Retardation films (F10-1) to (F12-1) were prepared in the same manner as that for the above retardation films (F4-1) to (F6-1), for which, however, the coating liquid (S4-1) was used.

### <Preparation of Retardation Film (F13-1)>

2,2′-Bis(3,4-dicarboxyphenyl)hexafluoropropanoic acid dianhydride (by Clariant Japan) (17.77 g, 40 mmol) and 2,2-bis (trifluoromethyl)-4,4′-diaminobiphenyl (by Wakayama Seika Kogyo) (12.81 g, 40 mmol) were put into a reactor (500 mL) equipped with a mechanical stirrer, a Dean-Stark apparatus, a nitrogen-introducing duct, a thermometer and a condenser tube. Next, a solution prepared by dissolving isoquinoline (2.58 g, 20 mmol) in m-cresol (275.21 g) was added to it, and stirred at 23° C. for 1 hour (600 rpm) to prepare a uniform solution. Next, the reactor was heated with an oil bath in order that the temperature inside the reactor could reach 180±3° C.; and with keeping the temperature as such, this was stirred for 5 hours to give a yellow solution. This was further stirred for 3 hours, then the heating and the stirring was stopped, and this was left cooled to room temperature to give a gel-like polymer.

Acetone was added to the yellow solution in the reactor to completely dissolve the gel, thereby preparing a diluted solution (7% by mass) . The diluted solution was added to isopropyl alcohol (2 L) little by little with stirring, and a white powder was thus precipitated. The powder was collected by filtration, put into 1.5 L of isopropyl alcohol and washed therein. The same operation was repeated once more for washing, and the powder was again collected by filtration. This was dried in an air-circulating thermostat oven at 60° C. for 48 hours, and then heated at 150° C. for 7 hours to give a polyimide powder (yield, 85%). The weight-average molecular weight (Mw) of the polyimide was 124,000, and the degree of imidation was 99.9%.

The polyimide powder was dissolved in methyl isobutyl ketone to prepare a 15 mas. % polyimide solution (coating liquid S5-1). The polyimide solution was applied onto the surface of a triacetyl cellulose-containing polymer film (FUJIFILM's trade name, ZRF80S; Re(550)=0.5 nm, Rth(550)=1.0 nm) in one direction thereon, using a rod coater. Next, this was dried in an air-circulating thermostat oven at 135±1° C. for 5 minutes and then in an air-circulating thermostat oven at 150±1° C. for 10 minutes to evaporate the solvent, thereby producing a retardation film (F13-1) having a polyimide layer (thickness, 9.3 nm). Its properties are shown in the following Table.

The optical properties of the retardation films (F1-1) to (F13-1) produced in the above were shown in the following Table.

Of the retardation films (F1-1) to (F13-1), (F2-1) to (F12-1) are examples of the retardation film of the first aspect of the invention, and (F1-1) and (F13-1) are comparative examples.

In the following Table, the unevenness of the retardation films was determined according to the method mentioned below.

### (Determination of Unevenness)

On the schaukasten set in a dark room, two polarizing plates were put in such a manner that their absorption axes were perpendicular to each other, and the retardation film produced in the above was put between the two polarizing plates. At the site separated by 1 m from this in the direction of 60 degrees from the normal direction, this was observed and checked for its unevenness according to the following criteria:
◯◯: No unevenness seen.
◯: Slight unevenness seen.
Δ: Some unevenness seen.
×: Much unevenness seen in the entire surface.

| Optical | | Support | | Optically Anisotropic Layer | | | | |
|---|---|---|---|---|---|---|---|---|
| Compensation | | | Thickness | Coating | Thickness | Re(550) | Rth(550) | Rth(450)/ |
| Film | | Type | (μm) | Liquid | (μm) | (nm) | (nm) | Rth(550) |
| F1-1 | Comparative | TD80UF | 80 | S1-1 | 4.3 | 0 | 326 | 1.160 |
| | Example | | | | | | | |
| F2-1 | Example | CAF3 | 140 | S1-1 | 2.8 | 0 | 212 | 1.160 |
| F3-1 | Example | CAF4 | 190 | S1-1 | 2.1 | 0 | 156 | 1.160 |
| F4-1 | Example | TD80UF | 80 | S2-1 | 3.0 | 0 | 326 | 1.100 |
| F5-1 | Example | CAF1 | 80 | S2-1 | 2.6 | 0 | 280 | 1.100 |
| F6-1 | Example | CAF3 | 140 | S2-1 | 1.9 | 0 | 212 | 1.100 |
| F7-1 | Example | TD80UF | 80 | S3-1 | 3.0 | 0 | 326 | 1.100 |
| F8-1 | Example | CAF1 | 80 | S3-1 | 2.6 | 0 | 280 | 1.100 |
| F9-1 | Example | CAF3 | 140 | S3-1 | 1.9 | 0 | 212 | 1.100 |
| F10-1 | Example | TD80UF | 80 | S4-1 | 3.0 | 0 | 326 | 1.100 |
| F11-1 | Example | CAF1 | 80 | S4-1 | 2.6 | 0 | 280 | 1.100 |
| F12-1 | Example | CAF3 | 140 | S4-1 | 1.9 | 0 | 212 | 1.100 |
| F13-1 | Comparative | ZRF80S | 80 | S5-1 | 9.3 | 0 | 370 | 1.065 |
| | Example | | | | | | | |

| | | Optical Compensation Film | | | |
|---|---|---|---|---|---|
| Optical Compensation | | Re(550) | Rth(550) | Rth(450)/ | |
| Film | | (nm) | (nm) | Rth(550) | Unevenness |
| F1-1 | Comparative | 2 | 370 | 1.123 | Δ |
| | Example | | | | |
| F2-1 | Example | 2 | 370 | 1.058 | ◯ |
| F3-1 | Example | 2 | 370 | 1.021 | ◯◯ |
| F4-1 | Example | 2 | 370 | 1.070 | ◯ |
| F5-1 | Example | 2 | 370 | 1.056 | ◯◯ |
| F6-1 | Example | 2 | 370 | 1.023 | ◯◯ |
| F7-1 | Example | 2 | 370 | 1.070 | ◯ |
| F8-1 | Example | 2 | 370 | 1.056 | ◯◯ |
| F9-1 | Example | 2 | 370 | 1.023 | ◯◯ |
| F10-1 | Example | 2 | 370 | 1.070 | ◯ |
| F11-1 | Example | 2 | 370 | 1.056 | ◯◯ |
| F12-1 | Example | 2 | 370 | 1.023 | ◯◯ |
| F13-1 | Comparative | 1 | 370 | 1.065 | X |
| | Example | | | | |

(Preparation of Polarizing plate (P1-1))

The retardation film (F1-1) was saponified. A stretched polyvinyl alcohol was made to adsorb iodine to prepare a polarizing film. Using a polyvinyl alcohol adhesive, the saponified retardation film (F1-1) was stuck to one surface of the polarizing film in a roll-to-roll process.

On the other hand, a commercial cellulose triacetate film (FUJITAC TD80UF, by FUJIFILM) was saponified. Using a polyvinyl alcohol adhesive, this was stuck to the other surface of the above polarizing film in a roll-to-roll process. This was dried at 70° C. for at least 10 minutes, thereby producing a polarizing plate (P1-1).

### (Preparation of Polarizing Plates (P2-1) to (P13-1))

Polarizing plates (P2-1) to (P13-1) were produced in the same manner as that for the polarizing plate (P1-1), for which, however, the retardation films (F2-1) to (F13-1) were used respectively in the place of the retardation film (F1-1).

### (Preparation of Retardation Film F111 (Negative A-Plate (A1)))

An unstretched laminate film 101 was produced through co-extrusion, comprising a layer [1] of a norbornene polymer (Nippon Zeon's Zeonoa 1020, glass transition temperature 105° C.), a layer [2] of a styrene-maleic anhydride copolymer (Nova Chemical Japan's Dylark D332; glass transition temperature 130° C., oligomer content 3% by mass) and a layer [3] of a modified ethylene-vinyl acetate copolymer {Mitsubishi Chemical's Modic AP A543; Vicat softening point 80° C.) and having a constitution of layer [1] (15 μm)/layer [3] (5 μm)/layer [2] (100 μm)/layer [3] (5 μm)/layer [1] (15 μm).

Next, the long unstretched laminate film 101 produced in the above was fed into a stretcher (Ichikin Industry's trade name FITZ). The stretcher has the function of stretching a long film in the cross direction, using a tenter, and the tenter is so designed that the distance between the tenter clips in the machine direction is narrowed while the film is held and conveyed. In the stretcher, the film was set at a temperature of 140° C. and, after 30 seconds, this was led to pass through a heating zone, and thereafter its stretching was started. In the machine direction, the film was relaxed and shrunk by 0.82 times (degree of shrinkage, 18%); and by the tenter clips, the film was stretched in the cross direction by 1.50 times (degree of stretching, 50%). After thus stretched, a retardation film F111 having a thickness of 114 μm was produced.

Re and Rth at a wavelength of 550 nm of the thus-produced retardation film F111 were determined according to the above-mentioned method using KOBRA 21ADH (by Oji Scientific Instruments). In-plane retardation Re(550) was 150 nm, and thickness-direction retardation Rth(550) was −75 nm. The in-plane slow axis was in parallel to the machine direction, and its fluctuation was ÷0.05°. The residual volatile content was at most 0.01% by mass. Accordingly, the retardation film F111 is a negative A-plate having an in-plane slow axis parallel to the machine direction.

### <<Production of Polarizing Plate>>

A stretched polyvinyl alcohol film was made to adsorb iodine to produce a polarizing film. Using an adhesive, the retardation film F111 was stuck to one surface of the polarizing film in a roll-to-roll process.

On the other hand, a commercial cellulose triacetate film (FUJITAC TD80UF, by FUJIFILM) was saponified. Using a polyvinyl alcohol adhesive, this was stuck to the other surface of the above polarizing film in a roll-to-roll process. This was dried at 70° C. for at least 10 minutes, thereby producing a polarizing plate (P20-1).

In this, the absorption axis of the polarizing film was in parallel to the slow axis of the retardation film F111.

(Preparation of Retardation Film F113 (negative A-plate (A2)))

As a material having a negative intrinsic birefringence, used was a fluorene skeleton-having copolycarbonate.

The polycarbonate was produced according to known interfacial polycondensation with phosgene. An aqueous sodium hydroxide solution and ion-exchanged water were put into a reactor equipped with a stirrer, a thermometer and a reflux condenser; and monomers [A] and [B] each having the structure mentioned below were dissolved in this, in a molar ratio of 86/14, and a small amount of hydrosulfite was added thereto. Next, methylene chloride was added to it, and phosgene was jetted into it at 20° C., taking about 60 minutes. Further, p-tert-butylphenol was added for emulsification, then triethylamine was added, and this was stirred at 30° C. for about 3 hours to stop the reaction. After the reaction, the organic layer was separated and collected, and methylene chloride was evaporated away, thereby producing a polycarbonate copolymer. The composition ratio of the thus-obtained copolymer was nearly the same as that of the starting materials used. The glass transition temperature was 235° C. As measured with an Ubbelohde viscometer at 20° C., the limiting viscosity of the copolymer in methylene chloride was 0.8.

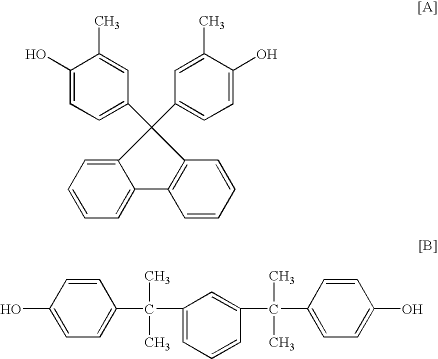

The copolymer was dissolved in methylene chloride to prepare a dope having a solid concentration of 18% by mass. The dope was cast into a film, thereby preparing an unstretched long film 103 having a thickness of 75 μm. The residual solvent amount in the unstretched film was 0.9% by mass.

The long unstretched film 103 produced in the above was fed into a stretcher (Ichikin Industry's trade name FITZ). The stretcher has the function of stretching a long film in the cross direction, using a tenter, and the tenter is so designed that the distance between the tenter clips in the machine direction is narrowed while the film is held and conveyed. In the stretcher, the film was set at a temperature of 245° C. and, after 30 seconds, this was led to pass through a heating zone, and thereafter its stretching was started. In the machine direction, the film was relaxed and shrunk by 0.85 times (degree of shrinkage, 15%); and by the tenter clips, the film was stretched in the cross direction by 1.45 times (degree of stretching, 45%). After thus stretched, a retardation film F113 having a thickness of 62 μm was produced.

Re and Rth at a wavelength of 550 nm of the thus-produced retardation film F113 were determined according to the above-mentioned method using KOBRA 21ADH (by Oji Scientific Instruments). In-plane retardation Re(550) was 136 nm, and thickness-direction retardation Rth(550) was −68 nm. The in-plane slow axis was in parallel to the machine direction, and its fluctuation was 10.05°. The residual volatile content was at most 0.01% by mass. Accordingly, the retardation film F113 is a negative A-plate having an in-plane slow axis parallel to the machine direction (longitudinal direction).

### <<Production of Polarizing Plate>>

A stretched polyvinyl alcohol film was made to adsorb iodine to produce a polarizing film. Using an adhesive, the retardation film F113 was stuck to one surface of the polarizing film in a roll-to-roll process.

On the other hand, a commercial cellulose triacetate film (FUJITAC TD80UF, by FUJIFILM) was saponified. Using a polyvinyl alcohol adhesive, this was stuck to the other surface of the above polarizing film in a roll-to-roll process. This was dried at 70° C. for at least 10 minutes, thereby producing a polarizing plate (P30-1).

In this, the absorption axis of the polarizing film was in parallel to the slow axis of the retardation film F113.

A stretched polyvinyl alcohol film was made to adsorb iodine to produce a polarizing film. A commercial cellulose triacetate film (FUJITAC TD80UF, by FUJIFILM) was saponified. Using a polyvinyl alcohol adhesive, this was stuck to both surfaces of the above polarizing film in a roll-to-roll process. This was dried at 70° C. for at least 10 minutes, thereby producing a comparative polarizing plate (P10-1).

### (Production of Liquid-Crystal Display Device)

### <<Production of Vertical Alignment Liquid-Crystal Cell>>

1% by mass of octadecyldimethylammonium chloride (coupling agent) was added to an aqueous 3 mas. % polyvinyl alcohol solution. This was applied onto an ITO electrode-having glass substrate in a mode of spin coating, then heated at 160° C., and rubbed to form a vertical alignment film. The rubbing direction was in the opposite directions in two glass substrates. The two glass substrates were combined to face each other via a cell gap (d) of about 5.0 μm. A liquid-crystal composition comprising main ingredients of an ester compound and an ethane compound (Δn: 0.06) was injected into the cell gap, thereby constructing a vertical alignment liquid-crystal cell A. The product of Δn and d was 300 nm.

To the upper and lower glass substrates of the above vertical alignment liquid-crystal cell, stuck were the above-produced polarizing plate (P1-1) and polarizing plate (P20-1) with an adhesive. This was designed as follows: As the polarizing plate on the backlight side, the polarizing plate (P1-1) was disposed, and as the polarizing plate on the viewing side, the polarizing plate (P20-1) was disposed. The retardation film (F1-1) in the polarizing plate (P1-1) was kept in contact with the glass substrate on the backlight side, and the retardation film F111 in the polarizing plate (P20-1) was in contact with the glass substrate on the viewing side.

The absorption axis of the polarizing plate (P1-1) was kept vertical to the absorption axis of the polarizing plate (P20-1).

The liquid-crystal display device (L1-1) has the constitution as in FIG. 1, in which the first polarizing film 3 is the polarizing plate on the backlight side, and the first retardation film 11 is the retardation film (F1-1) serving also as the protective film for the first polarizing film 3. The second retardation film 12 is the retardation film F111, and this serves also as the protective film for the second polarizing film 8.

A liquid-crystal display device (L0-1) was produced in the same manner as that for the liquid-crystal display device (L1-1), in which, however, the polarizing plate on the backlight side and that on the viewing side were changed to P0-1.

Liquid-crystal display devices (L2-1) to (L7-1) were produced in the same manner as that for the liquid-crystal display device (L1-1), in which, however, the polarizing plate on the backlight side was changed as in the following Table.

The liquid-crystal display devices (L0-1) to (L7-1) thus produced in the manner as above were tested for front and oblique light leakage and for color shift watched in front of the panel and in oblique directions thereto, according to the methods mentioned below. The results are shown in Table.

The liquid-crystal display device (L7-1) gave too much unevenness when watched in oblique directions, and therefore this could not be tested for oblique light leakage and oblique color shift.

### (1) Light Leakage (in the Normal Line Direction):

On the schaukasten set in a dark room, a liquid-crystal cell with no polarizing plate stuck thereto was put. Using a brightness meter (spectral radiation brightness meter, CS-1000 by Minolta) set at a distance spaced from the sample by 1 m in the normal line direction, the brightness (1) of the sample was measured.

Next, on the same schaukasten as above, a liquid-crystal display device with polarizing plates stuck thereto was set, and the brightness (2) was measured in the same manner as above. The ratio of the brightness (2) to the brightness (1), as percentage, is the front light leakage.

### (2) Light Leakage (in the Oblique Direction):

On the schaukasten set in a dark room, a liquid-crystal cell with no polarizing plate stuck thereto was put. Using a brightness meter (spectral radiation brightness meter, CS-1000 by Minolta) set in the left-hand direction of 45 degrees based on the rubbing direction of the liquid-crystal cell and spaced by 1 m from the sample in the direction rotated by 60 degrees with respect to the normal line direction of the liquid-crystal cell, the brightness (1) of the sample was measured.

Next, on the same schaukasten as above, a liquid-crystal display device with polarizing plates stuck thereto was set, and the brightness (2) was measured in the same manner as above. The ratio of the brightness (2) to the brightness (1), as percentage, is the oblique light leakage.

### (3) Color Shift in the Black State (in the Normal Line Direction):

On the schaukasten set in a dark room, a liquid-crystal cell with polarizing plates stuck thereto was put. At the site spaced by 1 m from the sample along the normal line direction, the liquid-crystal cell was checked for color shift and its intensity according to the following criteria. The color shift intensity was determined according to the following standards.
◯: No specific color shift seen.
◯Δ: Slight specific color shift seen.
Δ: A little specific color shift seen.
×: Specific color shift seen clearly.

### (4) Color Shift in the Black State (in the Oblique Direction):

On the schaukasten set in a dark room, a liquid-crystal cell with polarizing plates stuck thereto was put. At the site in the left-hand direction of 45 degrees based on the rubbing direction of the liquid-crystal cell and spaced by 1 m from the sample along the direction rotated by 60 degrees with respect to the normal line direction of the liquid-crystal cell, the sample was checked for color shift in the black state, under the same standards as in the above (3).

TABLE 1-1

| | Comparative | Comparative | | |
|---|---|---|---|---|
| | Example | Example | Example | Example |
| Display | L0-1 | L1-1 | L2-1 | L3-1 |
| Polarizing | P10-1 | P1-1 | P2-1 | P3-1 |
| Plate*1 | | | | |
| Protective Film | TD80UL | Retardation | Retardation | Retardation |
| | | Film F1-1 | Film F2-1 | Film F3-1 |
| Re(550) (nm) | 2 | 2 | 2 | 2 |
| Rth(550) (nm) | 44 | 370 | 370 | 370 |
| Rth(450)/ | 0.840 | 1.123 | 1.058 | 1.021 |
| Rth(550) | | | | |
| Polarizing | P10-1 | P20-1 | P20-1 | P20-1 |
| Plate*2 | | | | |
| Protective Film | TD80UL | Retardation | Retardation | Retardation |
| | | Film F111 | Film F111 | Film F111 |
| Re(550) (nm) | 2 | 150 | 150 | 150 |
| Rth(550) (nm) | 44 | −75 | −75 | −75 |
| Rth(550)/ | 22.00 | −0.50 | −0.50 | −0.50 |
| Re(550) | | | | |
| Slow Axis | Longitudinal | Longitudinal | Longitudinal | Longitudinal |
| | direction | direction | direction | direction |
| Light | >0.05 | 0.023 | 0.018 | 0.006 |
| Leakage*3 | | | | |
| Light | >0.05 | 0.028 | 0.022 | 0.011 |
| Leakage*4 | | | | |
| Color Shift*5 | ◯ | ◯ | ◯ | ◯ |
| Color Shift*6 | X | Δ | ◯Δ | ◯ |
| Unevenness*7 | ◯◯ | Δ | ◯ | ◯◯ |

| | Example | Example | Example |
|---|---|---|---|
| Display | L4-1 | L5-1 | L6-1 |
| Polarizing Plate*1 | P4-1 | P5-1 | P6-1 |
| Protective Film | Retardation | Retardation | Retardation |
| | Film F4-1 | Film F5-1 | Film F6-1 |
| Re(550) (nm) | 2 | 2 | 2 |
| Rth(550) (nm) | 370 | 370 | 370 |
| Rth(450)/Rth(550) | 1.070 | 1.056 | 1.023 |
| Polarizing Plate*2 | P20-1 | P20-1 | P20-1 |
| Protective Film | Retardation | Retardation | Retardation |
| | Film F111 | Film F111 | Film F111 |
| Re(550) (nm) | 150 | 150 | 150 |
| Rth(550) (nm) | −75 | −75 | −75 |
| Rth(550)/Re(550) | −0.50 | −0.50 | −0.50 |
| Slow Axis | Longitudinal | Longitudinal | Longitudinal |
| | direction | direction | direction |
| Light Leakage*3 | 0.020 | 0.018 | 0.006 |
| Light Leakage*4 | 0.025 | 0.022 | 0.012 |
| Color Shift*5 | ◯ | ◯ | ◯ |
| Color Shift*6 | ◯Δ | ◯Δ | ◯ |
| Unevenness*7 | ◯ | ◯◯ | ◯◯ |

| | Comparative | |
|---|---|---|
| | Example | Example |
| Display | L7-1 | L8-1 |
| Polarizing Plate*1 | P13-1 | P6-1 |
| Protective Film | Retardation | Retardation |
| | Film F13-1 | Film F6-1 |
| Re(550) nm | 2 | 2 |
| Rth(550) nm | 370 | 370 |
| Rth(450)/Rth(550) | 1.065 | 1.023 |
| Polarizing Plate*2 | P20-1 | P30-1 |
| Protective Film | Retardation | Retardation |
| | Film F111 | Film F113 |
| Re(550) nm | 150 | 136 |
| Rth(550) nm | −75 | −68 |
| Rth(550)/Re(550) | −0.50 | −0.50 |
| Slow Axis | Longitudinal | Longitudinal |
| | direction | direction |
| Light Leakage*3 | 0.006 | 0.006 |
| Light Leakage*4 | — | 0.011 |
| Color Shift*5 | ◯ | ◯ |
| Color Shift*6 | — | ◯ |
| Unevenness*7 | X | ◯◯ |

*1Polarizing Plate of Backlight side
*2Polarizing Plate of Viewing side
*3Light Leakage in a normal line direction
*4Light Leakage in an oblique direction
*5Color Shift in a normal line direction
*6Color Shift in an oblique direction
*7Unevenness in an oblique direction

Understood from the results shown in Table 1-1 is as follows:

The VA-mode liquid-crystal display devices comprising a combination of the retardation film of the first aspect of the invention and a negative A-plate are free from the problems of display unevenness, oblique light leakage and oblique color shift, and they are extremely good.

In particular, the VA-mode liquid-crystal display devices with, as mounted thereon, the retardation film of Examples of the invention (F4-1 to F6-1) that has an optically-anisotropic layer formed by the use of coating liquid S2-1 containing a discotic compound D-524 (liquid-crystal compound of formula (DI)) are especially good, as free from the problems of display unevenness, oblique light leakage and oblique color shift, and the thicknesses of their polarizing plates were thin.

2. Examples of Second aspect of the Invention:

### Example 1-2

### <Preparation of Retardation Film (F1-2)>

A commercial cellulose acetate film (thickness: 80 μm; FUJITAC TD80UF produced by FUJIFILM) was led to pass through a dielectric heating roll at 60° C. whereby the film surface temperature was elevated up to 40° C.; and then an alkali solution A having the formulation mentioned below was applied onto it in an amount of 14 ml/m², using a bar coater. Then, this was kept staying under a steam far-IR heater (by Noritake Company) heated at 110° C. for 10 seconds, and thereafter pure water was applied to it in an amount of 3 ml/m², also using a bar coater. In this stage, the film temperature was 40° C. Next, this was rinsed with water with a fountain coater and dewatered with an air knife, and this operation was repeated three times; and then this was kept staying in a drying zone at 70° C. for 2 seconds, and thus dried.

<Formulation of Alkali Solution A>

| | |
|---|---|
| Potassium hydroxide | 4.7 mas. pts. |
| Water | 15.7 mas. pts. |
| Isopropanol | 64.8 mas. pts. |
| Propylene glycol | 14.9 mas. pts. |
| C₁₆H₃₃O(CH₂CH₂O)₁₀H (surfactant) | 1.0 mas. pt. |

An alignment film coating liquid having the formulation mentioned below was continuously applied onto the saponified surface of the long cellulose acetate film produced in the above, using a wire bar #14. This was dried with hot air at 60° C. for 60 seconds and then with hot air at 100° C. for 120 seconds, thereby forming an alignment film thereon.

Formulation of Alignment Film-Coating Liquid

| | |
|---|---|
| Modified polyvinyl alcohol mentioned below | 10 mas. pts. |
| Water | 371 mas. pts. |
| Methanol | 119 mas. pts. |
| Glutaraldehyde | 0.5 mas. pts. |

### Modified Polyvinyl Alcohol:

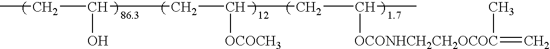

A discotic liquid-crystal compound-containing coating liquid (S1-2) having the formulation mentioned below was prepared, and this was continuously applied onto the alignment film formed in the above, using a wire bar. The film traveling speed was 20 m/min. During continuously heating it from room temperature up to 80° C., the solvent was dried away, and then this was heated in a drying zone at 120° C. for 90 seconds to thereby align the discotic liquid-crystal compound therein. Next, while the film temperature was kept at 90° C., this was irradiated with UV light at 500 mJ/cm², using a high-pressure mercury lamp, to fix the alignment of the liquid-crystal compound, thereby forming an optically anisotropic layer. The process thus gave a retardation film (F1-2)

### Formulation of Coating Liquid (S1-2):

Formulation of Discotic Liquid-Crystal Compound-Containing
Coating Liquid (S1-2)

| | |
|---|---|
| Discotic liquid-crystal compound (I) mentioned below | 91 mas. pts. |
| Ethyleneoxide-modified trimethylolpropane triacrylate | 9 mas. pts. |
| (V#360, by Osaka Organic Chemical) | |
| Photopolymerization initiator (Irgacure 907, by | 3 mas. pts. |
| Ciba-Geigy) | |
| Sensitizer (Kayacure DETX, by Nippon Kayaku) | 1 mas. pt. |
| Fluoropolymer A mentioned below | 0.4 mas. pts. |
| Methyl ethyl ketone | 212 mas. pts. |

### Discotic Liquid-Crystal Compound (I):

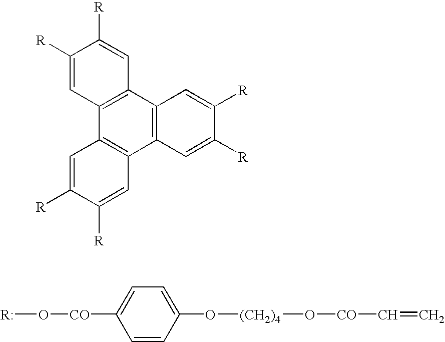

### Fluoropolymer A:

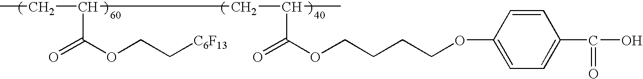

Mw=33000

Using an automatic birefringence meter (KOBRA-21ADH, by Oji Scientific Instruments), the optical properties of the thus-formed retardation film (F1-2) were determined. At a wavelength of 550 nm, Re was 2 nm, and Rth was 300 nm.

### <Preparation of Retardation Film (F2-2)>

### (Preparation of Cellulose Acetate Film (CAF1-2))

The following ingredients were put into a mixing tank and stirred under heat and dissolved, thereby preparing a cellulose acetate solution.

| Formulation of Cellulose Acetate Solution | Inner | Outer |
|---|---|---|
| (mas. pt.) | Layer | Layer |
| Cellulose acetate having a degree of | 100 | 100 |
| acetylation of 60.9% | | |
| Triphenyl phosphate (plasticizer) | 7.8 | 7.8 |
| Biphenyldiphenyl phosphate (plasticizer) | 3.9 | 3.9 |
| Methylene chloride (first solvent) | 293 | 314 |
| Methanol (second solvent) | 71 | 76 |
| 1-Butanol (third solvent) | 1.5 | 1.6 |
| Silica (particle size, 20 nm) | 0 | 0.8 |
| Retardation enhancer mentioned below | 1.4 | 1.4 |

### Retardation Enhancer:

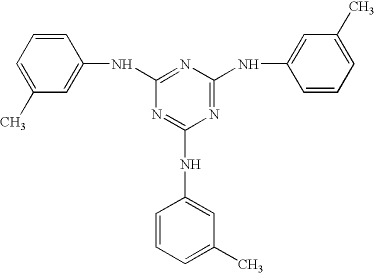

Thus obtained, the dope for inner layer and the dope for outer layer were cast onto a drum cooled at 0° C., using a three-layer co-casting die. The film having a residual solvent content of 70% by mass was peeled away from the drum. With both edges thereof fixed with a pin tenter, this was conveyed at a draw ratio in the machine direction of 110% and dried at 80° C.; and when the residual solvent content thereof reached 10%, this was dried at 110° C. Next, this was dried at 140° C. for 30 minutes, thereby producing a cellulose acetate film (CAF1-2) having a residual solvent content of 0.3% by mass (outer layer: 3 μm, inner layer: 74 μm, outer layer: 3 μm). The optical properties of the produced cellulose acetate film were determined.

The width of the obtained cellulose acetate film (CAF1-2) was 1340 mm, the thickness thereof was 80 μm. Using KOBRA 21ADH, its retardation (Re) at a wavelength of 550 nm was measured, and was 2 nm. Its retardation (Rth) at a wavelength of 550 nm was measured, and was 80 nm.

A retardation film (F2-2) was prepare in the same manner as that for the retardation film (F1-2), for which, however, the commercial cellulose acetate film (FUJITAC TD80UF, by FUJIFILM) used in preparation of the retardation film (F1-2) was changed to the cellulose acetate film (CAF1-2) produced in the above, and the thickness of the optically-anisotropic layer was changed in order that the retardation of the film could be as in the following Table.

The optical properties of the thus-formed retardation film (F2-2) were determined, using an automatic birefringence meter (KOBRA-21ADH, by Oji Scientific Instruments). At a wavelength of 550 nm, its Re was 2 nm and its Rth was 300 nm.

### <Preparation of Retardation Film (F3-2)>

In the same manner as that for preparation of the above-mentioned retardation film (F1-2), an alignment film was prepared on a commercial cellulose acetate film (FUJITAC TD80UF, by FUJIFILM).

A discotic liquid-crystal compound-containing coating liquid (S2-2) having the formulation mentioned below was prepared, and this was continuously applied onto the alignment film formed in the above, using a wire bar. The film traveling speed was 20 m/min. During continuously heating it from room temperature up to 80° C., the solvent was dried away, and then this was heated in a drying zone at 110° C. for 90 minutes to thereby align the discotic liquid-crystal compound therein. Next, while the film temperature was kept at 70° C., this was irradiated with UV light at 500 mJ/cm², using a high-pressure mercury lamp, to fix the alignment of the liquid-crystal compound, thereby preparing an optically anisotropic layer. The process thus gave a retardation film (F3-2).

### Formulation of Coatinq Liquid (S2-2):

Formulation of Discotic Liquid-Crystal Compound-Containing
Coating Liquid (S2-2)

| | |
|---|---|
| Discotic liquid-crystal compound D-524 | 91 mas. pts. |
| mentioned above | |
| Ethyleneoxide-modified trimethylolpropane triacrylate | 9 mas. pts. |
| (V#360, by Osaka Organic Chemical) | |
| Photopolymerization initiator (Irgacure 907, by | 3 mas. pts. |
| Ciba-Geigy) | |
| Sensitizer (Kayacure DETX, by Nippon Kayaku) | 1 mas. pt. |
| Fluoropolymer A mentioned above | 0.4 mas. pts. |
| Methyl ethyl ketone | 212 mas. pts. |

Using an automatic birefringence meter (KOBRA-21ADH, by Oji Scientific Instruments), the optical properties of the thus-formed retardation film (F3-2) were determined. At a wavelength of 550 nm, its Re was 2 nm and its Rth was 300 nm.

### <Preparation of Retardation Film (F4-2)>

A retardation film (F4-2) was formed in the same manner as that for the retardation film (F3-2), for which, however, the commercial cellulose acetate film (FUJITAC TD80UF, by FUJIFILM) used in formation of the retardation film (F3-2) was changed to the cellulose acetate film (CAF1-2) produced in the above, and the thickness of the optically-anisotropic layer was changed in order that the retardation of the films could be as in the following table.

### <Preparation of Retardation Films (F5-2) to (F6-2)>

A coating liquid (S3-2) was prepared in the same manner as that for the coating liquid (S2-2) used in preparation of the above retardation film (F3-2), for which, however, discotic compound D-521 was used in the place of D-524.

Retardation films (F5-2) and (F6-2) were prepared in the same manner as that for the above retardation films (F3-2) and (F4-2), for which, however, the coating liquid (S3-2) was used.

### <Preparation of Retardation Films (F7-2) to (F8-2)>

A coating liquid (S4-2) was prepared in the same manner as that for the coating liquid (S2-2) used in preparation of the above retardation film (F3-2), for which, however, discotic compound D-10 was used in the place of D-524.

Retardation films (F7-2) and (F8-2) were prepared in the same manner as that for the above retardation films (F3-2) and (F4-2), for which, however, the coating liquid (S4-2) was used.

### <Preparation of Retardation Film (F9-2)>

2,2′-Bis(3,4-dicarboxyphenyl)hexafluoropropanoic acid dianhydride (by Clariant Japan) (17.77 g, 40 mmol) and 2,2-bis (trifluoromethyl)-4,4′-diaminobiphenyl (by Wakayama Seika Kogyo) (12.81 g, 40 mmol) were put into a reactor (500 mL) equipped with a mechanical stirrer, a Dean-Stark apparatus, a nitrogen-introducing duct, a thermometer and a condenser tube. Next, a solution prepared by dissolving isoquinoline (2.58 g, 20 mmol) in m-cresol (275.21 g) was added to it, and stirred at 23° C. for 1 hour (600 rpm) to prepare a uniform solution. Next, the reactor was heated with an oil bath in order that the temperature inside the reactor could reach 180±3° C.; and with keeping the temperature as such, this was stirred for 5 hours to give a yellow solution. This was further stirred for 3 hours, then the heating and the stirring was stopped, and this was left cooled to room temperature to give a gel-like polymer.

Acetone was added to the yellow solution in the reactor to completely dissolve the gel, thereby preparing a diluted solution (7% by mass). The diluted solution was added to isopropyl alcohol (2 L) little by little with stirring, and a white powder was thus precipitated. The powder was collected by filtration, put into 1.5 L of isopropyl alcohol and washed therein. The same operation was repeated once more for washing, and the powder was again collected by filtration. This was dried in an air-circulating thermostat oven at 60° C. for 48 hours, and then heated at 150° C. for 7 hours to give a polyimide powder (yield, 85%). The weight-average molecular weight (Mw) of the polyimide was 124,000, and the degree of imidation was 99.9%.

The polyimide powder was dissolved in methyl isobutyl ketone to prepare a 15 mas. % polyimide solution (coating liquid S5-2). The polyimide solution was applied onto the surface of a triacetyl cellulose-containing polymer film (FUJIFILM's trade name, ZRF80S; Re(550)=0.5 nm, Rth(550)=1.0 nm) in one direction thereon, using a rod coater. Next, this was dried in an air-circulating thermostat oven at 135±1° C. for 5 minutes and then in an air-circulating thermostat oven at 150±1° C. for 10 minutes to evaporate the solvent, thereby producing a retardation film (F9) having a polyimide layer (thickness, 7.5 μm). Its properties are shown in the following table.

The test results of the retardation films (F1-2) to (F9-2) produced in the above are shown in the following table.

In the following table, the unevenness of the retardation films was determined according to the method mentioned below.

### (Determination of Unevenness)

On the schaukasten set in a dark room, two polarizing plates were put in such a manner that their absorption axes could be perpendicular to each other, and the retardation film produced in the above was put between the two polarizing plates. At the site separated by 1 m from this along the direction rotated by 60 degrees with respect to the normal line direction, this was observed and checked for its unevenness according to the following criteria:
◯◯: No unevenness seen.
◯: Slight unevenness seen.
Δ: Some unevenness seen.
×: Much unevenness seen in the entire surface.

| Optical | | | Optically Anisotropic Layer | | | | | Optical Compensation Film | | | |
|---|---|---|---|---|---|---|---|---|---|---|---|
| Compensation | | Support | Coating | Thickness | Re(550) | Rth(550) | Rth(450)/ | Re(550) | Rth(550) | Rth(450)/ | |
| Film | | Type | Liquid | (μm) | (nm) | (nm) | Rth(550) | (nm) | (nm) | Rth(550) | Uneveness |
| F1-2 | Example | TD80UF | S1-2 | 3.4 | 0 | 256 | 1.160 | 2 | 300 | 1.114 | ◯ |
| F2-2 | Example | CAF1 | S1-2 | 2.9 | 0 | 229 | 1.160 | 2 | 300 | 1.096 | ◯ |
| F3-2 | Example | TD80UF | S2-2 | 2.4 | 0 | 256 | 1.100 | 2 | 300 | 1.063 | ◯◯ |
| F4-2 | Example | CAF1 | S2-2 | 2.0 | 0 | 220 | 1.100 | 2 | 300 | 1.052 | ◯◯ |
| F5-2 | Example | TD80UF | S3-2 | 2.4 | 0 | 256 | 1.100 | 2 | 300 | 1.063 | ◯◯ |
| F6-2 | Example | CAF1 | S3-2 | 2.0 | 0 | 220 | 1.100 | 2 | 300 | 1.052 | ◯◯ |
| F7-2 | Example | TD80UF | S4-2 | 2.4 | 0 | 256 | 1.100 | 2 | 300 | 1.063 | ◯◯ |
| F8-2 | Example | CAF1 | S4-2 | 2.0 | 0 | 220 | 1.100 | 2 | 300 | 1.052 | ◯◯ |
| F9-2 | Comparative | ZRF80S | S5-2 | 7.5 | 0 | 300 | 1.065 | 1 | 300 | 1.065 | X |
| | Example | | | | | | | | | | |

### (Production of Polarizing Plate (P1-2))

The retardation film (F1-2) was saponified. A stretched polyvinyl alcohol was made to adsorb iodine to prepare a polarizing film. Using a polyvinyl alcohol adhesive, the saponified retardation film (F1-2) was stuck to one surface of the polarizing film in a roll-to-roll process.

On the other hand, a commercial cellulose triacetate film (FUJITAC TD80UF, by FUJIFILM) was saponified. Using a polyvinyl alcohol adhesive, this was stuck to the other surface of the above polarizing film in a roll-to-roll process. This was dried at 70° C. for at least 10 minutes, thereby producing a polarizing plate (P1-2).

### (Preparation of Polarizing Plates (P2-2) to (P9-2))

Polarizing plates (P2-2) to (P9-2) were produced in the same manner as that for the polarizing plate (P1-2), for which, however, the retardation film (F1-2) used for the polarizing plate (P1-2) was changed to the retardation films (F2-2) to (F9-2).

### <Preparation of Cellulose Acetate Film (T0-2)>

### (Preparation of Cellulose Acetate Solution)

The following ingredients were put into a mixing tank, and stirred and dissolved, thereby preparing a cellulose acetate solution A.

### Formulation of Cellulose Acetate Solution A:

| | |
|---|---|
| Cellulose Acetate having a degree of acetyl | 100.0 mas. pts. |
| substitution 2.94 | |
| Methylene Chloride (first solvent) | 402.0 mas. pts. |
| Methanol (second solvent) | 60.0 mas. pts. |

### (Preparation of Mat Agent Solution)

20 parts by mass of silica particles having a mean particle size of 16 nm (AEROSIL R972, by Nippon Aerosil) and 80 parts by mass of methanol were well stirred and mixed for 30 minutes to prepare a silica particle dispersion. The dispersion was put into a disperser along with the following formulation, and further stirred for 30 minutes or more to dissolve the ingredients, thereby preparing a mat agent solution.

### Formulation of Mat Agent Solution:

| | |
|---|---|
| Dispersion of Silica Particles having a mean particle | 10.0 mas. pts. |
| size of 16 nm | |
| Methylene Chloride (first solvent) | 76.3 mas. pts. |
| Methanol (second solvent) | 3.4 mas. pts. |
| Cellulose Acetate Solution A | 10.3 mas. pts. |

### (Preparation of Additive Solution)

The following ingredients were put into a mixing tank, and stirred under heat and dissolved, thereby preparing an additive solution.

### Formulation of Additive Solution:

| | |
|---|---|
| Optical Anisotropy Reducer mentioned below | 49.3 mas. pts. |
| Wavelength Dispersion Characteristics-Controlling Agent | 4.9 mas. pts. |
| mentioned below | |
| Methylene Chloride (first solvent) | 58.4 mas. pts. |
| Methanol (second solvent) | 8.7 mas. pts. |
| Cellulose Acetate Solution A | 12.8 mas. pts. |

### Optical Anisotropy Reducer

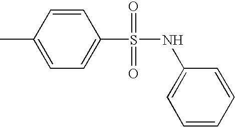

### Wavelength Dispersion Characteristics-Controlling Agent

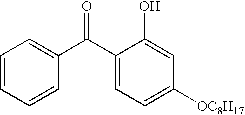

### (Preparation of Cellulose Acetate Film)

94.6 parts by mass of the above cellulose acetate solution A, 1.3 parts by mass of the mat agent solution, and 4.1 parts by mass of the additive solution were mixed, after separately filtered, and then cast using a band caster. In the above compositions, the ratio by mass of the optical anisotropy-reducing compound and the wavelength dispersion characteristics-controlling agent to the cellulose acetate was 12% and 1.2%, respectively. The film having a residual solvent content of 30% was peeled away from the band, anddriedat 140° C. for 40minutes, therebyproducinga longcellulose acetate film (T0-2) having a thickness of 80 μm. In-plane retardation (Re) of the obtained film was 1 nm (its slow axis is in the direction vertical to the machine direction of the film); and thickness-direction retardation (Rth) thereof was −1 nm.

(Production of Polarizing plate (P0-2))

A polarizing plate (P0-2) was produced in the same manner as that for the polarizing plate (P1-2), for which, however, the retardation film (F1-2) for the polarizing plate (P1-2) was changed to the cellulose acetate film (T0-2).

(Production of Polarizing plate (P10-2))

A polarizing plate (P10-2) was produced in the same manner as that for the polarizing plate (P1-2), for which, however, the retardation film (F1-2) for the polarizing plate (P1-2) was changed to a commercial cellulose acetate film (FUJITAC TD80UF, by FUJIFILM).

### (Production of Liquid-Crystal Display Device)

### <<Formation of Vertical Alignment Liquid-Crystal Cell>>

1% by mass of octadecyldimethylammonium chloride (coupling agent) was added to an aqueous 3 mas. % polyvinyl alcohol solution. This was applied onto an ITO electrode-having glass substrate in a mode of spin coating, then heated at 160° C., and rubbed to form a vertical alignment film. The rubbing direction was in the opposite directions in two glass substrates. The two glass substrates were combined to face each other via a cell gap (d) of about 5.0 μm. A liquid-crystal composition comprising main ingredients of an ester compound and an ethane compound (Δn: 0.06) was injected into the cell gap, thereby constructing a vertical alignment liquid-crystal cell A. The product of Δn and d was 300 nm.

In the absence of an electric field to the liquid-crystal cell, the wavelength dispersion characteristics of thickness-direction retardation Rth, Rth(450)/Rth(550) was 1.07. In this, Rth(450) and Rth(550) each mean thickness-direction retardation Rth of the liquid-crystal cell at 450 nm and 550 nm, respectively, in the absence of an electric field to the cell.

To the upper and lower glass substrates of the above vertical alignment liquid-crystal cell, stuck were the above-produced polarizing plate (P1-2) and polarizing plate (P0-2) with an adhesive. This was designed as follows: As the polarizing plate on the backlight side, the polarizing plate (P1-2) was disposed, and as the polarizing plate on the viewing side, the polarizing plate (P0-2) was disposed. The retardation film (F1-2) in the polarizing plate (P1-2) was kept in contact with the glass substrate on the backlight side, and the cellulose acetate film (T0-2) in the polarizing plate (P0-2) was in contact with the glass substrate on the viewing side.

The absorption axis of the polarizing plate (P1-2) was kept vertical to the absorption axis of the polarizing plate (P0-2).

The liquid-crystal display device (L1-2) has the constitution as in FIG. 5, in which the first polarizing film 3 is the polarizing plate on the backlight side, and the first retardation film 21 is the retardation film (F1-2) serving also as the protective film for the first polarizing film 3.

Liquid-crystal display devices (L0-2), (L2-2) to (L5-2) were produced in the same manner as that for the liquid-crystal display device (L1-2), in which, however, the polarizing plate on the backlight side was changed as in the following Table 1-2.

The liquid-crystal display devices (L0-2) to (L5-2) thus produced in the manner as above were tested for light leakage and for color shift watched in the normal line direction and in the oblique direction thereto, according to the methods mentioned below. The results are shown in Table 1-2.

### (1) Light Leakage (in the Normal Line Direction):

On the schaukasten set in a dark room, a liquid-crystal cell with no polarizing plate stuck thereto was put. Using a brightness meter (spectral radiation brightness meter, CS-1000 by Minolta) set at a distance spaced from the sample by 1 m along the normal direction, the brightness (1) of the sample was measured.

Next, on the same schaukasten as above, a liquid-crystal display device with polarizing plates stuck thereto was set, and the brightness (2) was measured in the same manner as above. The ratio of the brightness (2) to the brightness (1), as percentage, is the light leakage in the normal line direction.

### (2) Light Leakage (in the Oblique Direction):

On the schaukasten set in a dark room, a liquid-crystal cell with no polarizing plate stuck thereto was put. Using a brightness meter (spectral radiation brightness meter, CS-1000 by Minolta) set in the left-hand direction of 45 degrees based on the rubbing direction of the liquid-crystal cell and spaced by 1 m from the sample along the direction rotated by 60 degrees with respect to the normal line direction of the liquid-crystal cell, the brightness (1) of the sample was measured.

Next, on the same schaukasten as above, a liquid-crystal display device with polarizing plates stuck thereto was set, and the brightness (2) was measured in the same manner as above. The ratio of the brightness (2) to the brightness (1), as percentage, is light leakage in the oblique direction.

### (3) Color Shift in the Black State (in the Normal Line Direction)

On the schaukasten set in a dark room, a liquid-crystal cell with polarizing plates stuck thereto was put. At the site spaced by 1 m from the sample in the normal direction, the liquid-crystal cell was checked for color shift and its intensity according to the following criteria. The color shift intensity was determined according to the following standards.
◯: No specific color shift seen.
◯Δ: Slight specific color shift seen.
Δ: A little specific color shift seen.
×: Specific color shift seen clearly.

### (4) Color Shift in the Black State (in the Oblique Direction):

On the schaukasten set in a dark room, a liquid-crystal cell with polarizing plates stuck thereto was put. At the site in the left-hand direction of 45 degrees based on the rubbing direction of the liquid-crystal cell and spaced by 1 m from the sample along the direction rotated by 60 degrees with respect to the normal line direction of the liquid-crystal cell, the sample was checked for color shift in the black state, under the same standards as in the above (3).

### (5) Unevenness:

On the schaukasten set in a dark room, a liquid-crystal cell with no polarizing plate stuck thereto was put in such a manner that the electrode-having substrate could be on the side of the Schaukasten. At the site in the left-hand direction of 45 degrees based on the rubbing direction of the liquid-crystal cell and spaced by 1 m from the sample along the direction rotated by 60 degrees with respect to the normal line direction of the liquid-crystal cell, the sample was checked for display unevenness under the standards mentioned below.
◯◯: No unevenness seen.
◯: Slight unevenness seen.
Δ: Unevenness seen partly.
×: Unevenness seen in the entire surface.

TABLE 1-2

| | Comparative | Comparative | | |
|---|---|---|---|---|
| | Example | Example | Example | Example |
| Display | L0-2 | L1-2 | L2-2 | L3-2 |
| Polarizing | P10-2 | P1-2 | P2-2 | P3-2 |
| Plate*1 | | | | |
| Protective | TD80UL | Retardation | Retardation | Retardation |
| Film | | Film F1-2 | Film F2-2 | Film F3-2 |
| Re(550) (nm) | 2 | 2 | 2 | 2 |
| Rth(550) (nm) | 44 | 300 | 300 | 300 |
| Rth(450)/ | 0.840 | 1.114 | 1.096 | 1.063 |
| Rth(550) | | | | |
| Polarizing | P0-2 | P0-2 | P0-2 | P0-2 |
| Plate*2 | | | | |
| Protective | T0-2 | T0-2 | T0-2 | T0-2 |
| Film | | | | |
| Re(550) (nm) | 1 | 1 | 1 | 1 |
| Rth(550) (nm) | −1 | −1 | −1 | −1 |
| Light | >0.05 | 0.026 | 0.023 | 0.019 |
| Leakage*3 | | | | |
| Light | >0.05 | 0.041 | 0.035 | 0.029 |
| Leakage*4 | | | | |
| Color Shift*5 | ◯ | ◯ | ◯ | ◯ |
| Color Shift*6 | X | Δ | ◯Δ | ◯Δ |
| Unevenness*7 | ◯◯ | ◯ | ◯ | ◯◯ |

| | Example | Example |
|---|---|---|
| Display | L4-2 | L5-2 |
| Polarizing | P4-2 | P9-2 |
| Plate*1 | | |
| Protective | Retardation | Retardation |
| Film | Film F4-2 | Film F9-2 |
| Re(550) (nm) | 2 | 1 |
| Rth(550) (nm) | 300 | 300 |
| Rth(450)/ | 1.052 | 1.065 |
| Rth(550) | | |
| Polarizing | P0-2 | P0-2 |
| Plate*2 | | |
| Protective | T0-2 | T0-2 |
| Film | | |
| Re(550) (nm) | 1 | 1 |
| Rth(550) (nm) | −1 | −1 |
| Light Leakage*3 | 0.021 | 0.019 |
| Light Leakage*4 | 0.031 | — |
| Color Shift*5 | ◯ | ◯ |
| Color Shift*6 | ◯Δ | — |
| Unevenness*7 | ◯◯ | X |

*1Polarizing Plate of Backlight side
*2Polarizing Plate of Viewing side
*3Light Leakage in a normal line direction
*4Light Leakage in an oblique direction
*5Color Shift in a normal line direction
*6Color Shift in an oblique direction
*7Unevenness in an oblique direction

Understood from the results in Table 1-2 is as follows:

When a retardation film is inserted between a liquid-crystal cell and a polarizing element as a polarizing plate protective film in place of an ordinary polarizing plate protective film of a cellulose acetate film, in such a manner that thickness-direction retardation Rth of the retardation film could cancel the retardation of the liquid-crystal cell, then the device can solve the problems of oblique light leakage and color shift. The VA-mode liquid-crystal display device comprising the retardation film of the invention that satisfies 1.04≦Rth(450)/Rth(550)≦1.09 is free from display unevenness and is free from the problems of light leakage and color shift.

In particular, the VA-mode liquid-crystal display device comprising, as mounted thereon, a retardation film of the invention having an optically-anisotropic layer formed by the use of the coating liquid S2-2 that contains a discotic compound D-524 (liquid-crystal compound of formula (DI)) is especially good, as free from display unevenness and is free from the problems of oblique light leakage and oblique color shift.

Next described is a VA-mode liquid-crystal display device comprising, as mounted thereon, a second retardation film (biaxial film) and a retardation film of the second aspect of the invention (retardation film).

### (Formation of Retardation Film B for Second Retardation Film)

A thermoshrinking film was stuck to both surfaces of a polycarbonate film via an adhesive layer, then this was monoaxially stretched by 1.3 times at 152° C. to prepare a stretched film. Thus produced, the stretched film had an in-plane retardation (Re) of 270 nm and an Nz value of 0.50.

A vertical alignment liquid-crystal cell was produced in the same manner as in the above; and the polarizing plate (P3-2) produced in the above and the retardation film B also produced in the above were stuck to the upper and lower glass substrates of the vertical alignment liquid-crystal cell, using an adhesive. In this, the polarizing plate (P3-2) was the polarizing plate on the backlight side, and the retardation film (F3-2) in the polarizing plate (P3-2) was kept in contact with the glass substrate on the backlight side. Further, the polarizing plate (P0-2) produced in the above was stuck to the retardation film B in such a manner that the cellulose acetate film (T0-2) could be kept in contact with it, thereby producing a liquid-crystal display device (L8-2).

The liquid-crystal display device (L8-2) has the constitution as in FIG. 8, in which the absorption axis of the polarizing plate (P0-2) is perpendicular to the in-plane slow axis of the retardation film B and the absorption axis of the polarizing plate (P3-2) is perpendicular to the absorption axis of the polarizing plate (P0-2).

The liquid-crystal display device (L8-2) produced in the above was tested according to the same method as that for the liquid-crystal display device (L1-2), and the results are shown in the following table 2-2.

TABLE 2-2

| | Example |
|---|---|
| Display | L8-2 |
| Polarizing Plate*1 | P32 |
| Protective Film | Retardation Film F3-2 |
| Re(550) (nm) | 2 |
| Rth(550) (nm) | 300 |
| Rth(450)/Rth(550) | 1.063 |
| Polarizing Plate*2 | P0-2 |
| Protective Film | T0-2 |
| Retardation Film | Retardation Film B |
| Re(550) (nm) | 270 |
| Rth(550) (nm) | 0 |
| Nz value | 0.50 |
| Light Leakage*3 | 0.005 |
| Light Leakage*4 | 0.010 |
| Color Shift*5 | ◯ |
| Color Shift*6 | ◯ |

*1Polarizing Plate of Backlight side
*2Polarizing Plate of Viewing side
*3Light Leakage in a normal direction
*4Light Leakage in an oblique direction
*5Color Shift in a normal direction
*6Color Shift in an oblique direction

Understood from the results in Table 2-2 is as follows:

When the retardation film of the second aspect of the invention (first retardation film) is combined with a biaxial retardation film having an Nz value of 0.5 (second retardation film) , then the liquid-crystal display device comprising them is free from the problems of oblique light leakage and oblique color shift.

What is claimed is:

1. A retardation film comprising:
a polymer film, and, disposed thereon, an optically-anisotropic layer, of which thickness is equal to or less than 5 μm, of which in-plane retardation at a wavelength of 550 nm, Re(550), is from 0 to 10 nm, and of which thickness-direction retardation at the same wavelength, Rth(550), is from 250 to 450 nm;
and satisfying the following formula (1-1):
1.00≦Rth(450)/Rth(550)≦1.07 (1-1).

2. A retardation film comprising:
a polymer film, and, disposed thereon,
an optically-anisotropic layer, of which thickness is equal to or less than 5 μm, of which in-plane retardation at a wavelength of 550 nm, Re(550) is from 0 to 10 nm, and of which thickness-direction retardation at the same wavelength, Rth(550) is from 200 to 400 nm;
and satisfying the following formula (1-2):
1.04≦Rth(450)/Rth(550)≦1.09 (1-2).

3. The retardation film of claim 1, wherein in-plane retardation at a wavelength of 550 nm of the optically-anisotropic layer, Re(550), is from 0 to 10 nm, thickness-direction retardation at the same wavelength thereof, Rth(550), is from 200 to 400 nm, and the optically-anisotropic layer satisfies the following formula (2):
1.05<Rth(450)/Rth(550)≦1.15 (2).

4. The retardation film of claim 1, wherein the value, Rth(550)/d, calculated by dividing thickness-direction retardation at a wavelength of 550 nm, Rth(550), of the optically-anisotropic layer by the thickness, d, of the optically-anisotropic layer is equal to or more than 0.080.

5. The retardation film of claim 1, wherein the optically-anisotropic layer is formed of a polymerizable composition.

6. The retardation film of claim 5, wherein the polymerizable composition comprises at least one discotic liquid-crystal compound, having polymerizable group(s), and in the optically-anisotropic layer, the discotic structure unit of the discotic liquid-crystal compound is aligned horizontally to the layer face.

7. The retardation film of claim 6, wherein said at least one discotic liquid-crystal compound is a compound represented by the following formula (DI): 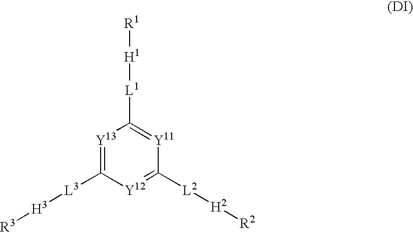
where Y¹¹, Y¹² and Y¹³ each independently represent a methine group or a nitrogen atom; L¹, L² and L³ each independently represent a single bond or a bivalent linking group; H¹, H² and H³ each independently represent following formula (DI-A) or (DI-B); and R¹, R² and R³ each independently represent following formula (DI-R) 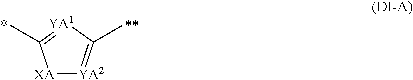
where, in formula (DI-A), YA¹ and YA² each independently represent a methine group or a nitrogen atom; XA represents an oxygen atom, a sulfur atom, a methylene group or an imino group; * indicates the position at which the formula bonds to any of L¹ to L³; and ** indicates the position at which the formula bonds to any of R¹ to R³: 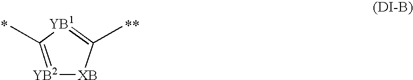
where, in formula (DI-B), YB¹ and YB² each independently represent a methine group or a nitrogen atom; XB represents an oxygen atom, a sulfur atom, a methylene group or an imino group; * indicates the position at which the formula bonds to any of L¹ to L³; and ** indicates the position at which the formula bonds to any of R¹ to R³: 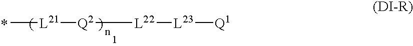
where, in formula (DI-R), * indicates the position at which the formula bonds to H¹, H² or H³ in formula (DI); L²¹ represents a single bond or a bivalent linking group; Q² represents a bivalent linking group having at least one cyclic structure; n1 indicates an integer of from 0 to 4; L²² represents —O—, —O—CO—, —CO—O—, —O—CO—O—, —S—, —NH—, —SO₂—, —CH₂—, —CH═CH— or —C≡C—, provided that, when the group has a hydrogen atom, the hydrogen atom may be substituted with a substituent; L²³ represents a bivalent linking group selected from —O—, —S—, —C(═O)—, —SO₂—, —NH—, —CH₂—, —CH═CH— and —C≡C—, and a group formed by linking two or more of these, provided that, when the group has a hydrogen atom, the hydrogen atom may be substituted with a substituent; and Q¹ represents a polymerizing group or a hydrogen atom.

8. The retardation film of claim 1, wherein the optically-anisotropic layer comprises at least one fluoroaliphatic group-containing polymer.

9. The retardation film of claim 1, wherein thickness-direction retardation at a wavelength of 550 nm of the polymer film, Rth(550), is equal to or more than 30 nm.

10. The retardation film of claim 1, wherein the polymer film is a cellulose acylate film.

11. The retardation film of claim 2, wherein in-plane retardation at a wavelength of 550 nm of the optically-anisotropic layer, Re(550), is from 0 to 10 nm, thickness-direction retardation at the same wavelength thereof, Rth(550), is from 200 to 400 nm, and the optically-anisotropic layer satisfies the following formula (2):
1.05≦Rth(450)/Rth(550)≦1.15 (2).

12. The retardation film of claim 2, wherein the value, Rth(550)/d, calculated by dividing thickness-direction retardation at a wavelength of 550 nm, Rth(550), of the optically-anisotropic layer by the thickness, d, of the optically-anisotropic layer is equal to or more than 0.080.

13. The retardation film of claim 2, wherein the optically-anisotropic layer is formed of a polymerizable composition.

14. The retardation film of claim 13, wherein the polymerizable composition comprises at least one discotic liquid-crystal compound, having polymerizable group(s), and in the optically-anisotropic layer, the discotic structure unit of the discotic liquid-crystal compound is aligned horizontally to the layer face.

15. The retardation film of claim 14, wherein said at least one discotic liquid-crystal compound is a compound represented by the following formula (DI): 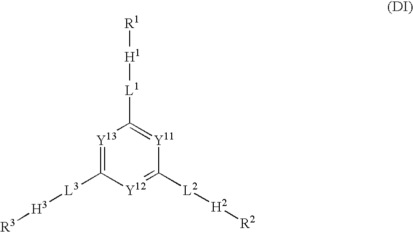
where Y¹¹, Y¹² and Y¹³ each independently represent a methine group or a nitrogen atom; L¹, L²and L³ each independently represent a single bond or a bivalent linking group; H¹, H² and H³ each independently represent following formula (DI-A) or (DI-B); and R¹, R² and R³ each independently represent following formula (DI-R): 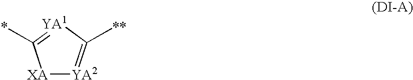
where, in formula (DI-A), YA¹ and YA² each independently represent a methine group or a nitrogen atom; XA represents an oxygen atom, a sulfur atom, a methylene group or an imino group; * indicates the position at which the formula bonds to any of L¹ to L³; and ** indicates the position at which the formula bonds to any of R¹ to R³: 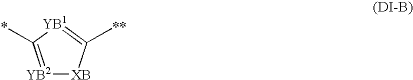
where, in formula (DI-B), YB¹ and YB² each independently represent a methine group or a nitrogen atom; XB represents an oxygen atom, a sulfur atom, a methylene group or an imino group; * indicates the position at which the formula bonds to any of L¹ to L³; and ** indicates the position at which the formula bonds to any of R¹ to R³: 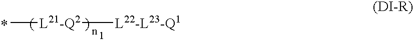
where, in formula (DI-R), * indicates the position at which the formula bonds to H¹, H² or H³ in formula (DI); L²¹ represents a single bond or a bivalent linking group; Q² represents a bivalent linking group having at least one cyclic structure; n1 indicates an integer of from 0 to 4; L²² represents —O—, —O—CO—, —CO—O—, —O—CO—O—, —S—, —NH—, —SO₂—, —CH₂—, —CH═CH— or —C≡C—, provided that, when the group has a hydrogen atom, the hydrogen atom may be substituted with a substituent; L²³ represents a bivalent linking group selected from —O—, —S—, —C(═O)—, —SO₂—, —NH—, —CH₂—, —CH═CH— and —C≡C—, and a group formed by linking two or more of these, provided that, when the group has a hydrogen atom, the hydrogen atom may be substituted with a substituent; and Q¹ represents a polymerizing group or a hydrogen atom.

16. The retardation film of claim 2, wherein the optically-anisotropic layer comprises at least one fluoroaliphatic group-containing polymer.

17. The retardation film of claim 2, wherein thickness-direction retardation at a wavelength of 550 nm of the polymer film, Rth(550), is equal to or more than 30 nm.

18. The retardation film of claim 2, wherein the polymer film is a cellulose acylate film.

19. A polarizing plate comprising at least a polarizing film and a retardation film as set forth in claim 1.

20. A polarizing plate comprising at least a polarizing film and a retardation film as set forth in claim 2.

21. A liquid-crystal display device comprising a retardation film as set forth in claim 1 as a first retardation film.

22. A liquid-crystal display device comprising a retardation film as set forth in claim 2 as a first retardation film.

23. The liquid-crystal display device of claim 21, comprising:
a pair of polarizing films with their absorption axes being perpendicular to each other,
a pair of substrates disposed between the pair of polarizing films, and
a liquid crystal layer of liquid-crystal molecules sandwiched between the substrates, in which the liquid-crystal molecules are aligned substantially vertically to the substrates in OFF state with no external electric field applied thereto.

24. The liquid-crystal display device of claim 22, comprising:
a pair of polarizing films with their absorption axes being perpendicular to each other,
a pair of substrates disposed between the pair of polarizing films, and
a liquid crystal layer of liquid-crystal molecules sandwiched between the substrates, in which the liquid-crystal molecules are aligned substantially vertically to the substrates in OFF state with no external electric field applied thereto.

25. The liquid-crystal display device of claim 23, which further comprises a second retardation film formed of a polymer stretched film.

26. The liquid-crystal display device of claim 24, which further comprises a second retardation film formed of a polymer stretched film.

27. The liquid-crystal display device of claim 25, wherein in-plane retardation at a wavelength of 550 nm of the second retardation film, Re (550), and thickness-direction retardation at the same wavelength thereof, Rth(550), satisfy the following formula (3-1) and (4-1):
70 nm≦Re(550)≦210 nm (3-1)
−0.6≦Rth(550)/Re(550)≦−0.4 (4-1).

28. The liquid-crystal display device of claim 26, wherein in-plane retardation at a wavelength of 550 nm of the second retardation film, Re(550), and the Nz value, Nz=Rth(550)/Re(550)+0.5, at the same wavelength satisfy the following formula (3-2) and (4-2):
200 nm≦Re(550)≦300 nm (3-2)
0.3<Nz<0.7 (4-2).

29. The liquid-crystal display device of claim 26, wherein in-plane retardation at a wavelength of 550 nm of the second retardation film, Re(550), and the Nz value, Nz=Rth(550)/Re(550)+0.5, at the same wavelength satisfy the following formula (5-2) and (6-2):
240 nm≦Re(550)≦290 nm (5-2)
0.4<Nz<0.6 (6-2).

30. The liquid-crystal display device of claim 26, wherein the second retardation film satisfies the following formula (7-2):
0.7≦Re(450)/Re(550)≦1.1 (7-2).

31. The liquid-crystal display device of claim 25, wherein the second retardation film is any of a cellulose acylate film, a norbornene film, a polycarbonate film, a polyester film and a polysulfone film.

32. The liquid-crystal display device of claim 26, wherein the second retardation film is any of a cellulose acylate film, a norbornene film, a polycarbonate film, a polyester film and a polysulfone film.

33. The liquid-crystal display device of claim 25, wherein the second retardation film is directly laminated on one of the pair of polarizing films so that its in-plane slow axis is perpendicular to the absorption axis of the polarizing film.

34. The liquid-crystal display device of claim 26, wherein the second retardation film is directly laminated on one of the pair of polarizing films so that its in-plane slow axis is perpendicular to the absorption axis of the polarizing film.
